(19) United States
(12) Patent Application Publication
(10) Pub. No.: US 2026/0161652 A1
(43) Pub. Date: Jun. 11, 2026

(54) DATA RELATIONSHIP ANNOTATION AND MATCHING

(71) Applicant: SAP SE, Walldorf (DE)

(72) Inventor: Michael Hladik, Walldorf (DE)

(73) Assignee: SAP SE, Walldorf (DE)

(21) Appl. No.: 18/976,226

(22) Filed: Dec. 10, 2024

(51) Int. Cl. G06F 16/2457; G06F 16/21; G06F 16/28

(52) U.S. Cl. CPC G06F 16/24573; G06F 16/212; G06F 16/288

(57) ABSTRACT

Techniques and solutions are disclosed for annotating and processing data across schemas using a matching model. Data associated with a first source schema is received from a first source and submitted to the matching model. The model generates results identifying matches between instances in the first source schema and a second source schema, where the schemas may be the same or different. Based on these results, annotations are added to the first source schema to reflect relationships with data in the second source schema. Annotations may include derivation relationships and schema mappings, such as those implemented in knowledge graphs. Annotated data may be used to train or refine the matching model iteratively. Additionally, previously ingested data may be reprocessed with updated models, and version information of the matching model associated with annotated data to track updates and provide traceability.

### FIELD

The present disclosure generally relates to matching schema instances across schemas.

### BACKGROUND

In contemporary data management and analysis, knowledge graphs serve as foundational frameworks for organizing, representing, and integrating structured knowledge from diverse sources. Knowledge graphs encode information in a graph-based format, with nodes representing entities and edges denoting relationships. This interconnected structure facilitates advanced analytics, natural language processing (NLP), and artificial intelligence (AI) applications.

The processes used to ingest and transform data prior to its integration into a knowledge graph or schema can significantly impact subsequent applications, such as training neural language models. However, data ingestion pipelines are often ad hoc, making it difficult to track the specific operations performed, particularly when pipeline components or their configurations change over time. This lack of traceability complicates determining whether datasets were processed consistently or if previously processed data requires reprocessing due to changes in pipeline versions.

Data ingestion pipelines are typically tailored to specific data sources, and relationships between datasets from different sources are rarely established. As a result, even when semantic relationships exist between datasets, they often remain unlinked, limiting their utility. Similar challenges can arise when handling datasets associated with the same schema but processed at different times or under different conditions. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are disclosed for annotating and processing data across schemas using a matching model. Data associated with a first source schema is received from a first source and submitted to the matching model. The model generates results identifying matches between instances in the first source schema and a second source schema, where the schemas may be the same or different. Based on these results, annotations are added to the first source schema to reflect relationships with data in the second source schema. Annotations may include derivation relationships and schema mappings, such as those implemented in knowledge graphs. Annotated data may be used to train or refine the matching model iteratively. Additionally, previously ingested data may be reprocessed with updated models, and version information of the matching model associated with annotated data to track updates and provide traceability.

In one aspect, the present disclosure provides a process of processing and annotating data. First data is received from a first source. The first data is associated with a first source schema and corresponds to instances of types and properties defined in the first source schema. Data from the first data source is submitted to a matching model. In response to the submission, results are received from the matching model. The results identify matches between at least a portion of instances of types in the first source schema and instances of types in a second source schema, where the second source schema is either the same as or different from the first source schema. In response to receiving the results, the data in the first source schema is annotated to reflect relationships with corresponding second data in the second source schema.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram illustrated an architecture and an end-to-end process for ingesting data from sources into a graph, and then deploying information from the graph to one or more channels.

FIG. 2 is a diagram illustrating subprocesses for a process of ingesting data from a source into a graph.

FIG. 3 describes example input and output components that can be used with the subprocesses of FIG. 2.

FIG. 4 is a diagram illustrating an example processing environment for converting inputs to outputs using configurations for subprocesses, as well as steps that can be performed using the processing environment.

FIG. 5 is a diagram illustrating an example computing environment in which disclosed techniques can be implemented.

FIG. 6 is a schema, such as a core schema, illustrating relationships between various data artifacts of the schema, including a model, a process performed using the model, and components of the process.

FIG. 7 is a schema, such as core schema, illustrating relationships between various data artifacts of the schema, including a model type, a process type, and types for elements of a process.

FIG. 8 is a diagram an implementation of the schema of FIG. 6.

FIGS. 9A and 9B present a schema representing the combination of the schema of FIG. 6 and the schema of FIG. 7.

FIG. 10 is a diagram of a graph representation of various related models, including a core model, a taxonomy model, and a plurality of domain models.

FIG. 11 is a schema illustrating an implementation of a core model, a domain model, and a taxonomy model corresponding to elements of FIG. 10.

FIGS. 12A-12C provide a schema illustrating how core, taxonomy, and domain model elements can be represented and related..

FIG. 13 illustrates operations, and associated events that can be generated as a result of the operations, in processing source data using disclosed techniques.

FIG. 14 is a diagram of a computing environment in which disclosed techniques can be implemented that is similar to the computing environment of FIG. 5, but further includes a matcher component that can be used to match data between different source schemes, and a matcher training component that can be used to train the matcher component.

FIG. 15 is a diagram illustrating subprocesses for ingesting source data into a graph format, but further including subprocesses for training a matcher and using the matcher.

FIG. 16 is a schema implementation similar to the schema implementation of FIG. 8, but including elements related to the matcher and training of the matcher.

FIG. 17 is a flowchart of a process of processing and annotating data.

FIG. 18 is a diagram of an example computing environment in which disclosed techniques can be implemented.

FIG. 19 is an example cloud computing environment that can be used in conjunction with the technologies described herein.

### DETAILED DESCRIPTION

### EXAMPLE 1

### Overview

Continuing from the Background, the present disclosure provides techniques and solutions for identifying elements of a process, using the particular example of an ingestion pipeline for data that can be used for training purposes, such as for training a neural language model. Identifying elements of the process provides a number of benefits, including enabling modification or reexecution of processes when an element is altered. For example, modifying an algorithm used for transforming data can be used to generate an updated process that uses the modified algorithm in place of the original algorithm, or to notify a user, such as a developer, of the new algorithm version, allowing them to determine whether a process should be updated to use the new algorithm.

As for reexecution, it may be desirable to have data to be used for a common purpose processed consistently to make training as accurate as possible. Thus, if new data will be processed by an updated algorithm, it may be useful to reprocess existing data using the updated algorithm.

Defining standard types of process elements for making process more directly comparable and for automating actions in response to changes in process elements. For example, events can be raised when particular actions occur. These actions can include those described above, such as an event being raised when a process element changes, where the event triggers processing using the updated process element. Events can also trigger actions that cause users to be alerted to processing actions. For example, if data is processed using an updated version of an algorithm, an event can be raised that triggers an action for a user to review the results of the processing and determine if the results are suitable for further processing.

Information about processes used to process data can be added to, or otherwise associated with data sets resulting from the processing. This can facilitate comparing data sets, such as to understand where differences might arise. Such annotations can also be used to trigger reprocessing of data, as previously described.

Techniques and solutions are also provided for matching data between data sets, where each data set is associated with a schema. A matching model can be trained, such as with known matches of instances between two data sets, whether using the same schema or different schemas. Matching can include adding instances of one data set as instances of that data set's schema or matching instances between two data sets. In at least some implementations, rather than directly adding instances from one data set to another, a data set is annotated with information linking data between the data sets.

### EXAMPLE 2

### Example Ingestion of Data From Sources Into a Graph and Deployment of Graph Data To Channels

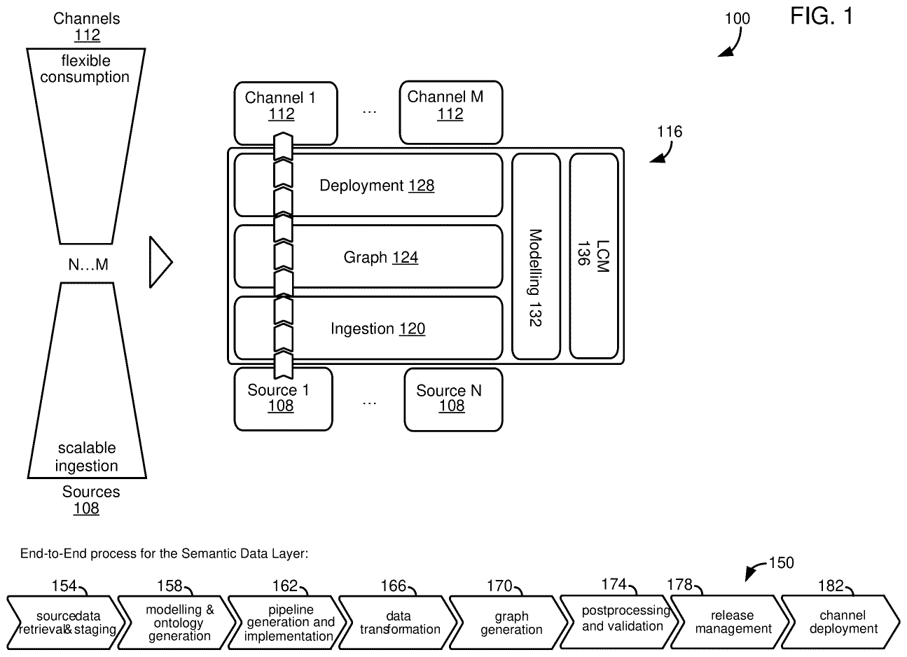

FIG. 1 illustrates a computing environment 100 that can be used in a particular implementation of disclosed techniques. In particular, the computing environment 100 facilitates a process of ingesting data from sources 108 to channels 112. A source 108 refers to an origin or provider of data, which can include databases, file systems, APIs, streaming services, or any other system or repository that produces or stores data for processing. Each source 108 can be associated with specific schemas, formats, or semantic models, and may provide structured, semi-structured, or unstructured data. Sources 108 in FIG. 1 represent these origins of data that are ingested into the system for subsequent processing and utilization in one or more channels 112.

A channel 112 refers to a target or endpoint where processed data is delivered or used. Channels 112 can represent systems, applications, services, or workflows that consume ingested data to perform specific tasks, such as analytics, visualization, machine learning, or decision-making. Each channel 112 may require data in a particular format or schema, and may integrate with multiple data sources. Channels 112 in FIG. 1 represent these destinations for processed data, which can leverage one or more sources 108 to fulfill their operational needs.

The sources 108 and channels 112 can have a N . . . M relationship. In other words, a given channel 112 can use data from one or more data sources 108. Data from a given data source 108 can be used with multiple channels.

A processing framework 116 is shown that processes data from one or more sources 108 and provides the data to one or more channels. Generally, the processing framework 116 includes an ingestion process 120 that ingests data from a source 108 and stores the data in a particular representation. In a specific example, the representation is a graph 124, such as a knowledge graph. The graph 124 can be associated with a schema, such as semantic schema, as will be further described.

The schema of the graph 124 is referred to as a local schema. Data from a source 108 is typically associated with a source schema, where such associating can be part of the ingestion process 120. In some cases, rather than converting data from the source schema to the local schema, the data is instead mapped from the source schema to the local schema, such as through annotations to the data. The data in the source schema can be referred to as a subgraph. Elements of the subgraph, such as semantic elements of the subgraph schema and instances of those elements, that are mapped to the local schema can be referred to as “derivatives” of elements of the local schema. In a particular example, a derivative relationship can be a predicate type in a knowledge graph, where the linked data corresponds to a subject and an object related by the predicate.

The ingestion process 120 can include operations such as data formatting and data cleansing. The ingestion process 120 can also include operations such as associating data with elements of the graph. Ingested data can, for example, be linked to particular components of a knowledge graph, including using an ontology defined for the knowledge graph. That is, a particular set of data can be annotated as being an instance of a particular class of the knowledge graph, and values in the set of data can be assigned to various properties defined for the class.

Deployment processes 128 can be defined for processing data to be provided to one or more channels 112. The deployment processes 128 can include operations such as extracting or transforming data from a format of the graph 124 to a format used by the channel.

Deployment process 128 also include operations to send the data, optionally with any formatting or transformation, to a channel 112, such as a data store used by the channel.

A modelling component 132 can be used to perform operations such as associating data from a source 108 with a particular schema, such as a schema for the graph 124. A lifecycle management component 136 can be used to maintain version information for processing components, as well as data produced during processing. For example, processed data can be tagged with version information for a process or process elements used in its production. The lifecycle management component 132, in some cases, can perform actions related to version changes, such as raising event or triggering actions in response to a raised event.

The computing environment 100 can be referred to as a semantic data layer.

Semantic data refers to data being not just raw values, but data that is associated with information (such as metadata) that describes what the data represents. For example, the graph 124 can store data values from a source 108, as well as information linking that data to elements of a knowledge graph. The semantic information can facilitate downstream use cases for the data, such as where training of a neural language model is more effective if training data includes not just the data but the semantic context of the data.

FIG. 1 outlines operations 150 for defining a process to ingest data from sources 108 and deploy it to channels 112. For example, at 154, processes are defined that can be executed to obtain data from a source 108 and stage the data for further processing. Defining processes to ingest data can include defining software functionality for extracting information from repositories, databases, files, or through application programing interfaces (APIs). The operations at 154 can include identifying where data from the source 108 will be stored prior to further processing as well as processing for cleaning or organizing source data.

Modelling and ontology generation processes are defined at 158. Operations at 158 can include operations to define how an ontology or knowledge graph is to be constructed.

The operations at 158 can also include defining process for how incoming data from a source 108 will be linked to a particular schema, such as a particular knowledge graph, which may have an associated ontology.

Operations at 162 include defining pipelines for processing data, including implementing various functionality to be performed as part of a pipeline. Pipeline operations can include operations to clean, transform, or integrate data. For example, a pipeline can be responsible for converting source data to a standardized format. The pipelines define operations at a general level, while specific operations, including data transformations, can be performed at 166.

Operations to generate a graph 124 are defined at 170. Operations to generate a graph 124 can include program logic for ingesting the transformed data into a graph, such as processes for creating nodes and edges that represent entities and their relationships. In particular implementations, graph generation operations can define how RDF (Resource Description Framework) triples will be generated to represent the ingested data in the graph 124, or a schema linked to the graph.

Operations are specified at 174 for reviewing and validating the graph 124 to confirm that it accurately represents the data and relationships. The operations can include defining, such as by domain experts, automated validation checks and manual review processes.

Processes can be defined for correcting any errors or inconsistencies encountered during validation operations.

At 178, operations are defined for versioning data and managing releases of processed data. These operations can be used to provide the correct version of the graph 124 to users and applications (including as channels 112). Processes can be defined to document and manage updates or changes to the graph 124.

At 182, platforms and applications where the graph 124 will be deployed can be defined, as well as operations that define how data from the graph will be provided to a channel 112. For example, operations can be defined for deploying a knowledge graph to web applications, APIs, data analytics platforms, and other channels 112 where users or computing processing can interact with the data.

Note that the computing environment 100, particularly the processing framework 116, can be a reuseable component. For example, standard processes, subprocesses, and their components can be defined at a more general level. For particular data ingestion processes, elements of these standard processes can be linked, and the standard processes can be associated with particular implementations of the process. The particular implementations can also be reusable. The same data transformation operations, for example, can be performed in processing data from two different sources. That is, for example, a specific implementation of a process element can be used so long as the input is comparable with the implementation and the output is suitable for downstream processing.

### EXAMPLE 3

### Example Subprocesses in a Source to Graph Process

An overall process can be broken down into different elements, where the elements can be reused between different processes. Sources and subprocesses are two mechanisms for separating process elements into logical units. For example, an overall process of generating a graph from source data can progress in different phases, which can be referred to as subprocesses. Subprocesses can serve as synchronization points or points at which events can be raised, and actions taken. Synchronization points themselves can be a type of event/action. For example, synchronization can include determining that a subprocess has completed and notifying a user of the completion. The user can then determine whether the results of executing the subprocess indicate that further processing can be performed. Validation actions can themselves be events that can trigger further actions, such as proceeding to a next subprocess of an overall process.

In a source to graph process, an overall source to graph process can be defined at the granularity of a source. That is, assuming it is desired to ingest data from multiple sources, separate source to graph process are defined for each source. Although the processes are defined separately, the processes can have the same general elements, or even particular implementations of such elements. Among other things, having different processes for different sources allows processes to be performed asynchronously. For example, data sources can be updated at different frequencies, and having separate processes can allow updated data from one source to be processed even if another source does not have updated data.

While the term “source” embraces many different types of sources, specific examples of sources that can be used with a source to graph process include SAP Enterprise Architecture Framework (SEAF), SAP Enterprise Architecture Reference Library (SEARL), and American Productivity and Quality Center (APQC). These sources define local schemas from both a technical level and a semantic perspective. That is, for example, a technical format may be that data is stored in a relational format, whereas the semantic perspective can include linking the data to a semantic description, such as an ontology or storing data in a knowledge graph. These data sources typically require at least some differences in implementing subprocesses and subprocess components, such as to extract, transform, and store content in a graph format. In some cases, multiple sources can have their data extracted into a common graph, or at least different graphs mapped to a common format, such as a local schema. However, the release cycles for the sources can differ, and the asynchronous nature of the processes for the sources allows data to be processed separately for each source, where results are synchronized with the common graph.

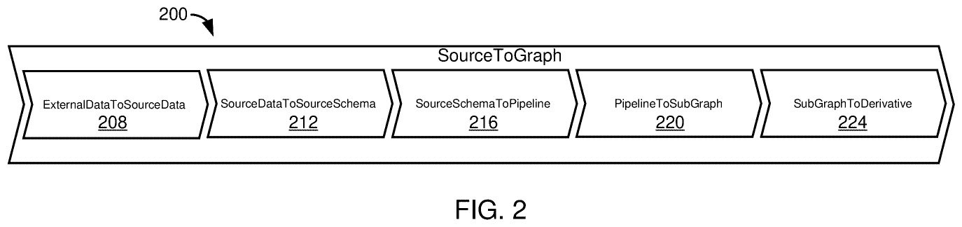

FIG. 2 illustrates an overall source to graph process 200. The process 200 includes a number of subprocesses. An external data to source data subprocess 208 is responsible for obtaining and staging source data for further processing. A source data to source schema process 212 is responsible for mapping the source data to a particular schema defined for the source data. A source schema to pipeline subprocess 216 takes the source data, now integrated with the source schema, into a processing pipeline that can include operations to clean, format, or transform source data. A pipeline to subgraph subprocess 220 takes data from the pipelines and adds the data to a subgraph graph, which can be a subgraph of the graph 124 of FIG. 1. A subgraph to derivative data subprocess 224 analyzes data in the subgraph and relates it to the local schema of the graph 124 of FIG. 1.

The subprocesses 208-224 can represent general operations that are performed during a source to graph process 200. These subprocesses 208-224 can be associated with implementations that are associated with a particular source. In a sense, the subprocesses 208-220 can be thought of as base classes in a computing language such as C++, where implementations specific for a given source correspond to derived classes of the base class.

As discussed in Example 1, elements of a process, such as the subprocesses 208-224 can change over time. Subprocesses 208-224 can be associated with version information, which provides a time dependency for data resulting from a subprocess. For example, data produced by a subprocess can be associated with a version identifier of the subprocess. Thus, data can be associated with an identifier that can be used to determine exactly how data was processed during the subprocess.

Versioning of subprocesses can be related to versioning of components used in a subprocess. A subprocess may have an input component, a processing component, and an output component, or can use multiple of these types of components. A change to one of these components can result in a new version of a subprocess. Thus, it can be precisely identified how particular data in a data set, such as a subgraph, was produced. This information can be used in various ways, including when determining whether data should be reprocessed to account for changes in a subprocess of the process used to ingest the data initially.

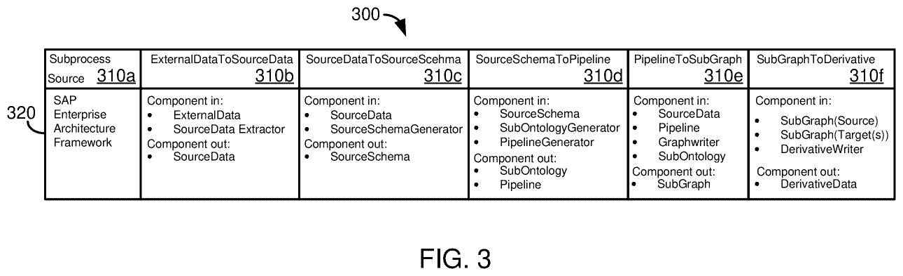

FIG. 3 illustrates how the implementation of a subprocess can be defined from elements, referred to as components. As with the subprocess themselves, components of a subprocess can represent general data artifacts usable in defining subprocesses, as well having implementations for specific subprocesses of a specific process. A data artifact refers to any representation of data within a computing system, including both abstract definitions and concrete instances of data. Abstract definitions can include schema elements, models, classes, or templates that define the structure, relationships, semantics, or associated operations of data, such as methods or functions that can be performed on instances of the artifact. Concrete instances can include individual data points, records, objects, or entities that conform to or are derived from these definitions. A data artifact may represent static or dynamic data and can exist in various forms, including structured, semi-structured, or unstructured data. It can also include metadata or annotations associated with data, such as information describing its provenance, relationships, or intended use, as well as operations or behaviors tied to the artifact's purpose or role within a system.

In particular, FIG. 3 provides a table 300 that includes columns 310b-310f for specific subprocesses of a source to graph process for a source indicated in column 310a. In row 320, where SAP Enterprise Architecture Framework is used as the source, the external data-to-source data subprocess 310b can have input components of external data and a source data extractor. The output of the subprocess 310b is source data. Note that in addition to having input components and output components, components can have different natures, in the sense of being data (including as represented in a data artifact), input or output, or processing (also referred to as algorithms). While subprocesses for different sources can have the same general components, the implementations of the components can differ as needed given the nature of the source data.

The subprocesses of columns 310c-310f are generally similar to the subprocess of column 310b, in that they have input and output components, where the components can be data artifacts or algorithms. The source data-to-source schema subprocess of column 310c includes input components of source data and a source schema generator algorithm. The output is a source schema.

The source schema-to-pipeline subprocess of column 310d has input components of a source schema, and input algorithmic components of a SubOntologyGenerator and a Pipeline generator. The output components are a subontology and a pipeline.

The pipeline to subgraph subprocess of column 310e has input components of the source data (such as produced by the external data to source data subprocess of column 310a) and a pipeline produced by the subprocess of column 310d. The input components of the subprocess of column 310d further include a graph writer that writes data to the graph and a subontology that is used by the graph writer. The pipeline-to-subgraph subprocess outputs a subgraph.

Column 310f represents a subgraph to derivative subprocess that links data in a graph to data in another graph, such as a local graph. The subgraph-to-derivative subprocess has input components of a subgraph from a source and a subgraph of a target, where it attempts to match data of the source to data (or semantic elements) of the target, such as using respective schemas of the source and target. An input component of a derivative writer operates on the subgraphs, and produces an output component of derivative data, which annotations link data between the processed data set in a source schema and a local schema.

### EXAMPLE 4

### Example Conversions of Inputs to Outputs Using Subprocess Configuration

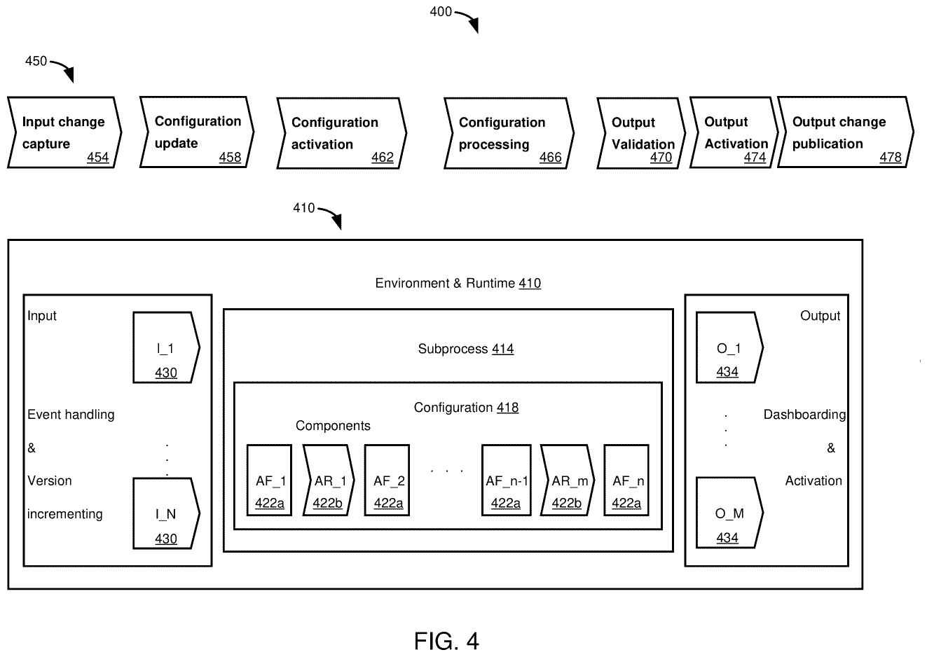

FIG. 4 illustrates a computing environment and processes, collectively 400, involved in lifecycle management of processes and process elements, including subprocesses and components.

The computing environment and processes 400 include an environment and runtime 410, where processes and their subprocesses and components are executed. An example subprocess 414 has a configuration 418, where the configuration includes components, shown as components 422a, 422b. Components 422a are data artifacts that correspond to a particular data type or data structure that stores data. Examples of data artifacts include relational database tables, RDF triples, and JSON objects. Components 422b are algorithms, such as algorithms that process data from one or more components 422a and produce one or more outputs that can also be components 422.

As shown, the components 422a, 422b are arranged sequentially, where a data artifact component 422a is provided as input to an algorithm component 422b, producing an output data artifact component 422a, which in turn can be input to further algorithm components 422b. A subprocess can have one or more final output data artifact components 422a, which can serve as final outputs of an overall process or can serve as inputs for a subsequent subprocess.

One or more inputs 430 can be provided to the subprocess 414, such as data artifacts that are outputs of a preceding subprocess. These inputs 430 can thus serve as input data artifact components 422a. Similarly, a final output data artifact component 422a can be an overall output 434 of the subprocess 414, which can then be provided as input to a subsequent subprocess.

Inputs 430 and outputs 434 can be associated with particular events, and particular actions can be triggered based on a particular event. For example, the availability of a new input 430 can trigger the execution of subsequent subprocesses that operate on the input. An output 434 can be associated with events such as alerting a user to the availability of new data. A user can choose to activate the output 434, such as if it passes quality checks, which then serves as an input to downstream subprocesses. While in some cases manual validation of outputs 434 is used, in other cases validation can be skipped or validations can be performed in an automated manner. When automated, successfully passing validations can cause an output 434 to be made available as an input to a downstream process.

FIG. 4 also illustrates a process 450 that can be carried out if a subprocess is modified, or if new or altered input data becomes available. At 454, a change to an input is captured. The change to an input can include new input data being available, which can include previously processed data that has been modified, such as being processed by an updated subprocess than was previously used in providing the input.

At 458 a change to a subprocess configuration is received. The change to a subprocess can include adding, removing, or reorganizing components 422a, 422b. The change to a subprocess can also include changing a definition or format of a data artifact component 422a, or changing the algorithm used in an algorithm component 422b. If the configuration update is received, the update can be applied and then the updated configuration activated at 462.

When input is to be processed by the subprocess 414, the subprocess can be executed at 466. Output of the subprocess can be validated at 470, where if the output is validated, the output can be activated, making it available for use by downstream subprocesses, at 474. An output change notification can be published at 478. The output change notification can alert subprocess that use the output of the subprocess 414 that new data is available to be processed.

Note that all or a portion of the operations of the process 450 can be performed. That is, in some cases an update to the configuration 418 of the subprocess 414 can be received without new data being available to be processed. In this case, operations at 458 and 462 are performed, but not other operations. Similarly, new input can be made available for processing in the absence of a change to the configuration 418 of the subprocess 414. In this case, operations 454 and 466-478 are performed, but not operations 458 and 462.

As previously described, inputs and outputs of subprocesses can be associated with version information that specifies what version of a subprocess, and therefore its components, was used in producing a particular output. When data is processed using the subprocess 414, incremented versions of previously produced output data artifact components 422a can be produced. This allows the outputs of different subprocess versions to be identified. Version information can be carried between subprocesses, such that an incremented version of an output that serves as input to a subsequent process in turn produces an incremented version of the output of the subsequent process.

A variety of mechanisms can be used to track version information. In a particular example, semantic versioning can be used when a subprocess or subprocess component is updated. A version number can be specified as MAJOR. MINOR. PATCH, where a MAJOR version is associated with incompatible API changes, a MINOR version is associated with added functionality that is backwards compatible, and a PATCH version involves backwards compatible bug fixes. This notation can be extended, such as by having extensions for pre-release and build metadata. For example, a version that has not been activated can be designated as an alpha version.

In some cases, multiple components of a subprocess can change as part of a single update. In this case, the version information for the subprocess can be determined by aggregating the changes at the component level. For example, if one component is updated to a new minor version and another component is updated to a new patch version, both the minor version and the patch version of the subprocess are updated. In some cases, changes to multiple components can result in multiple instances of the same type of version update being performed, such as if two components are subject to minor version updates. In this case, rather than incrementing the version identifier of the subprocess by a single minor version, it is incremented twice.

### EXAMPLE 5

### Example Computing Environment for Defining and Executing Processes

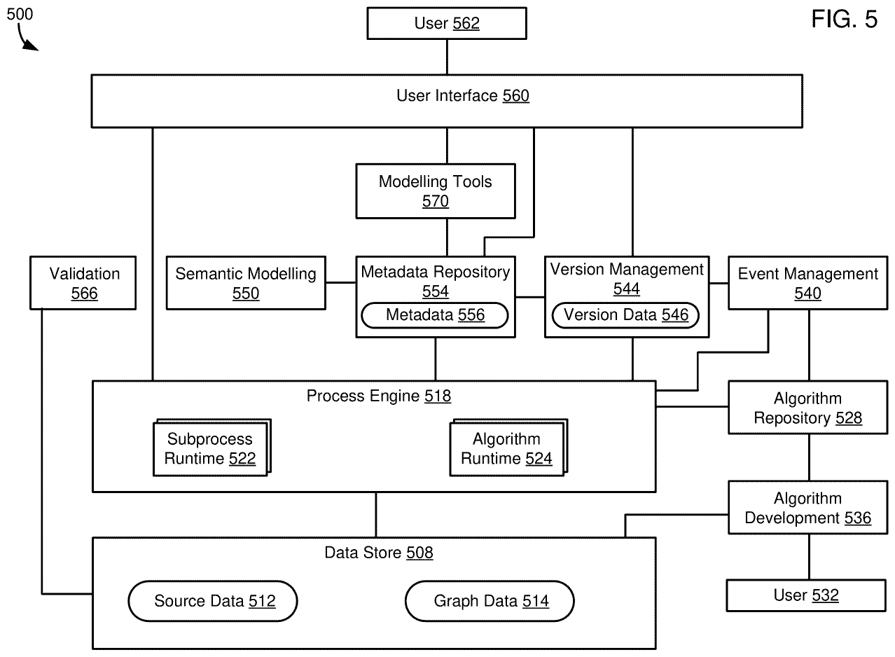

FIG. 5 is a diagram of a computing environment 500 in which disclosed techniques can be implemented. A data store 508, such as a relational database or an object store, can store source data 512 and graph data 514. The source data 512 can be data that was retrieved from an external source, such as a source 108 of FIG. 1. The graph data 514 can correspond to data of the graph 124, or, in cases where data is not directly stored in a local graph, the graph data can be stored in a separate graph where, at least after processing, the graph data can be mapped to a local graph. Graph data 514 can be stored in a manner that directly reflects the structure of the graph, or in a manner that may not directly reflect the structure of the graph, but can be used to construct the graph and obtain its structural details. For example, data can be stored as nodes and edges, or, for a knowledge graph, the graph data 514 can correspond to RDF triples.

A process engine 518 can read information from, and write information to, the data store 508. For example, a subprocess can read source data 512 or graph data 514, or can write updated source data or graph data, such as after performing operations defined by the components of the subprocess. The process engine 518 includes one or more subprocess runtimes 522 and one or more algorithm runtimes 524, where an algorithm runtime can be called by the execution of a subprocess in a subprocess runtime.

As part of executing an algorithm in the algorithm runtime 524, the algorithm runtime can access algorithms in an algorithm repository 528. Accessing algorithms can include calling an algorithm for execution with a particular set of input data.

A user 532 can interact with an algorithm development component 536. In some cases, the algorithm development component 536 can be an Integrated Development Environment (IDE). The user 532 can cause new algorithms to be deployed to the algorithm repository 528, or can update versions of algorithms. The deployment of a new algorithm version is broadcasted through the event management 540. Typically, if new algorithms are deployed and a corresponding event is created, the user 532 also creates a subprocess, or modifies an existing subprocess, to use the new algorithm.

As previously explained, updates to algorithms, data artifact components, or subprocesses can be associated with version management information, including where a subgraph produced through a source to graph process can include identifiers for subprocesses used in processing data, or where intermediate data can include identifiers of subprocesses previously executed in producing the intermediate data.. Accordingly, the algorithm repository 528 can notify an event management component 540 when a component or process is updated. In turn, the event management component 540 can raise an event with a version management component 544.

The version management component 544 can update version information for processes, subprocesses, or components, including storing the information in version data 546. The event management component 540 can generate additional events in response to version changes, either through an initial notification from the algorithm repository 528 or in response to a communication from the version management component 544. The event management component 540 can trigger other actions, such as triggering operations by the process engine 518. For example, an updated version of a subprocess being available can result in the event management component 540 generating a command to the process engine 518 to reprocess previously processed data using the updated subprocess.

A semantic modelling component 550 maintains schemas that provide semantic meaning to source data, such as knowledge graph or an ontology. A metadata repository 554 stores metadata 556, which can be used to maintain and provision parts of an overall process model, including provisioning the process engine 518 with definitions of subprocesses or subprocess components. That is, the metadata repository 554 can store process definitions, and cause code implementing the process definitions to be executed by the process engine 518.

A user interface 560 can allow a user 562 to access various components of the computing environment, including the semantic modelling component 550, the metadata repository 554, the version management component 544, and the event management component 540. The user interface 560 can allow the user to access a validation component 566. The validation component 566 can perform various actions. For example, the validation component 566 can provide the user interface 560 with information about the results of executing a subprocess, and in response the user can choose to validate or not validate the results. If the results are validated, the validation component 566 can communicate with the event management component 540, such as where the event management component notifies the process engine 518 that an output of one subprocess is approved for use with downstream subprocesses.

Various operations can be performed in the computing environment 500. A user 562 can, through the user interface 560, access the semantic modelling component 550 and define semantic models. Through the user interface 560, a user 562 can define sources, processes, subprocesses, and component, which can be stored in the metadata 556. If metadata 556 is changed for an existing source, process, subprocess, or component, messages can be sent to the event manager 540, which can take actions as have been previously described.

As described, a user 532 can access the algorithm development component 536 to define or modify algorithms for use in subprocesses. When an algorithm is activated for use, a communication can be sent to the event manager 540, which can trigger actions such as determining whether an update to an algorithm should result in reprocessing of data. Metadata 556 for an algorithm can also be changed, which can trigger an event of the event management component 540. For example, a change in a sequence in which an algorithm is called may affect metadata defining how the algorithm relates to other components, but the algorithm itself remains unchanged.

In modifying sources or processes defined for sources using the modelling tools 570, a user 562 can select to activate new or modified sources, processes, or process elements. In some cases, these new or modified elements can be processed automatically in response to other processes. For example, a putative new subprocess version may be defined automatically based on changes to a component of the subprocess, such as changing the definition of a data artifact component or the processing performed by an algorithm component. Before the new version of the subprocess is executed, at least in some cases, the new version of the subprocess is required to be activated by the user 562.

When a subprocesses is triggered for execution, it can be executed in the process engine 518, using the subprocess runtime 522 and the algorithm runtime 524. Execution of a subprocess produces one or more outputs, such as output data artifacts, which can be stored in the data store 508. The completion of the subprocess can raise an event with the event manager 540, such as where the event manager notifies a user 562 that new output data is available, so it can be approved by the user prior to that output data being provided as input to a downstream process. Information about the output can be stored in the version data 546, such as associating the result with an identifier of the subprocess used to produce the output.

### EXAMPLE 6

### Example Schemas for Models, Processes, and Process Elements

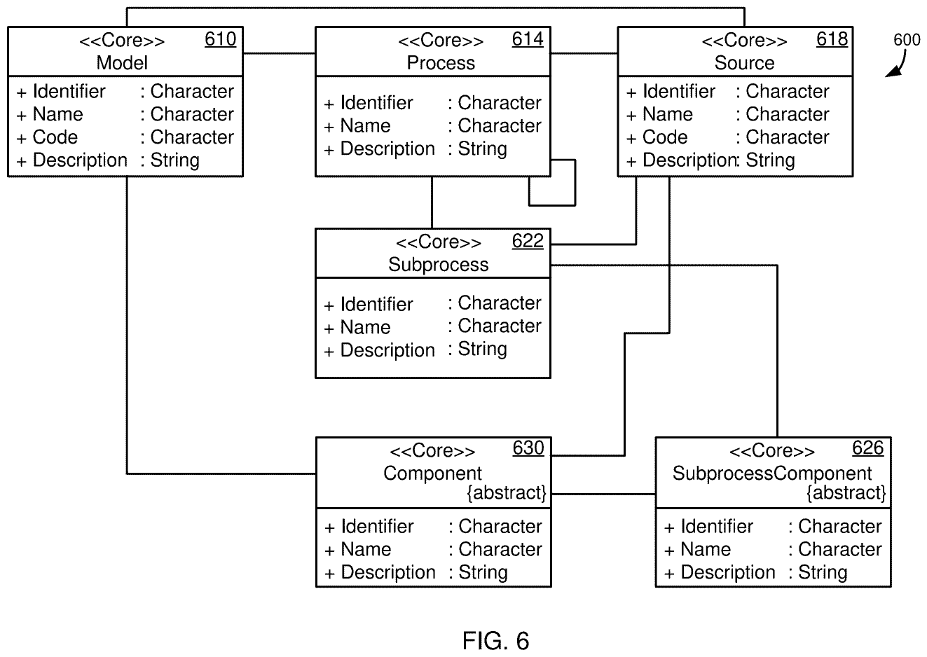

FIGS. 6-9 provide further details about how processes and their constituent elements can be represented and related. In this content, the term “model” refers to a description of the overall configuration, data, and process structures used to process and store source data in a graph. A model type provides a template for a process and expresses dependencies between processes, subprocesses, and components. Model types can be used to generate executable processes that use particular implementations of process elements specific to a particular source. Thus disclosed techniques provide a structured way of representing processes, which facilitates the reuse of subprocesses and components, as well as establishing a provenance chain that identifies how particular data was generated. In this context, a provenance chain is a record or lineage that traces the sequence of processes, subprocesses, components, and their respective versions involved in generating specific data. This allows the system to associate data outputs with the specific inputs, configurations, and processing steps, including the versions of those elements, enabling traceability, reproducibility, and accountability.

FIG. 6 provides a schema 600 that describes how a model can be related to model components. A definition 610 of a model data artifact is associated with a definition 614 of a process data artifact. In practice, a given model can be associated with multiple processes, while each process is associated with a single model. A process can also be nested within other processes, allowing for hierarchical relationships between processes.

The definition 610 of the model artifact is associated with a definition 618 of a source data artifact. A model can have multiple sources, but each source is associated with a single model. A source defines a particular process for retrieving specific data, such as identifying a location of a repository from which data will be retrieved, as well as methods, such as APIs, used to retrieve the data.

The definition 614 of the process data artifact is also related to the definition 618 of a source data artifact. In particular, a given process data artifact is associated with exactly one source, while each source can be associated with multiple processes.

The definition 614 of the process artifact is related to a definition 622 of a subprocess data artifact. A given subprocess can be related to one process, while a given process can be related to one or more subprocesses. The definition 622 of the subprocess data artifact is also related to the definition 618 of the source artifact. Specifically, each subprocess is associated with a single source, but a given source can be associated with multiple subprocesses.

The definition 622 of the subprocess data artifact is related to a definition 626 of a subprocess component data artifact. In particular, a subprocesses includes one or more subprocess components, while a given subprocess component is related to a single subprocess. Note that the definition 626 of the subprocess component data artifact is labelled as “abstract.” In this case, a subprocess component serves as a template, where in use a class that implements the abstract subprocess component is defined, so that, for example, a common type of subprocess component can be associated with different implementations, such as those suitable for use with a particular subprocess or with a particular source.

The definition 626 of the subprocess component data artifact is related to a definition 630 of a component data artifact. A subprocess component can reference one component in a given role (input, processing, output), and a given component can be referenced by multiple subprocess components. Components can refer to, for example, types of data artifacts or algorithms, while a subprocess component refers to a component in the specific context of a particular subprocess, including its interactions with other subprocess components.

The definition 630 of the component data artifact is also related to the definition 618 of the source data artifact and the definition 614 of the model data artifact. Specifically, components are associated with a single model, while a given model can have one or more components. Each component is associated with a single source, but a given source can be associated with one or more components.

In implementation, the data artifact definitions shown in the schema 600 can be extended to include attributes beyond those shown, such as attributes that allow related instances of the data artifacts to be tracked. For instance, the definition 626 of the subprocess data artifact can include an attribute that serves as a foreign key to an identifier of a process in an instance of the definition 614 of the process data artifact.

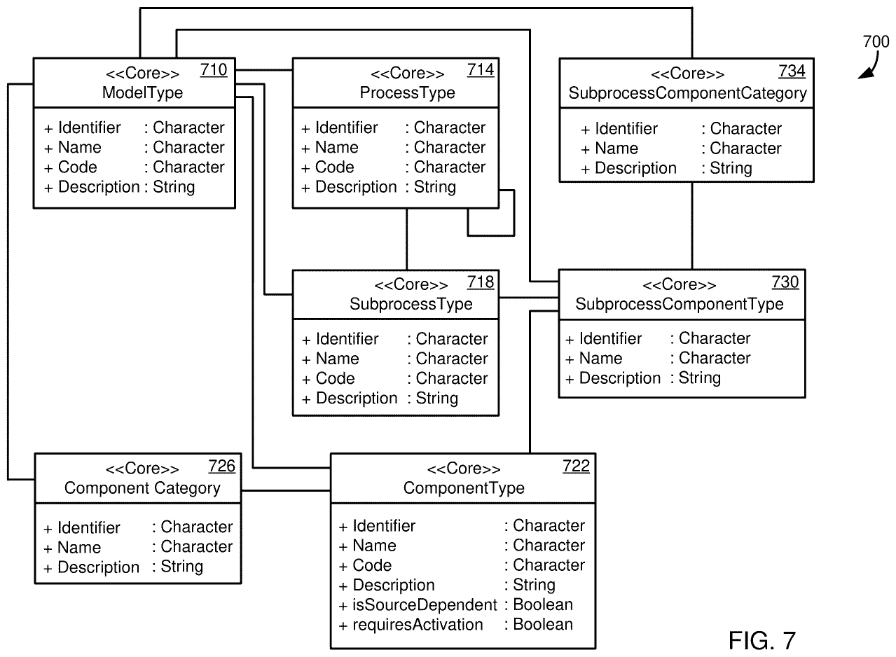

FIG. 7 provides a schema 700 that illustrates relationships between different data artifacts that define types, such as for types of data artifacts represented in the schema 600.

For example, the schema 700 illustrates that a definition 710 of a model type data artifact is related to a definition 714 of a process type data artifact, a definition 718 of a subprocess type data artifact, a definition 722 of a component type data artifact, a definition 726 of a component category data artifact, a definition 730 of a subprocess component type data artifact, and a definition 734 of subprocess component category data artifact.

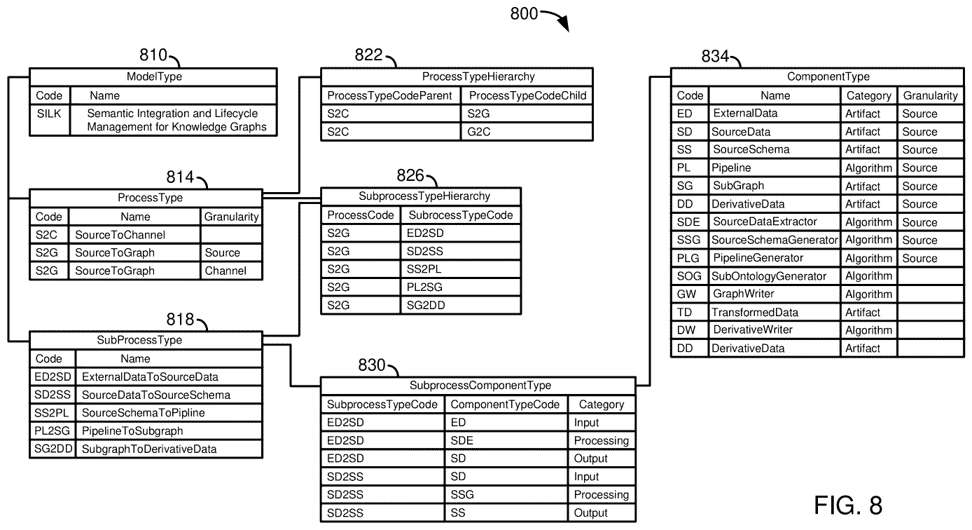

FIG. 8 provides a specific implementation 800 of the schema 700. It can be seen that a model type data artifact 810 is linked to a process type data artifact 814, which contains three different process types. The model type data artifact 810 is also linked to a subprocess type data artifact 818. The subprocess type data artifact 818 provides identifiers of several subprocess types included in the model type. These subprocesses types can be for a specific process type for the model type, such as being subprocess of the SourceToGraph process type represented in the process type data artifact 810.

A process type hierarchy data artifact 822 defines relationships between process types of the process type data artifact 814. For example, both the source-to-graph process and the graph-to-channel process can be defined as child processes of a source-to-channel process.

A subprocess type hierarchy data artifact 826 associates particular subprocess types of the subprocess type data artifact 818 with particular processes of the process type data artifact 814. In the example shown, all subprocesses in this hierarchy are subprocesses of the source-to-graph process.

A given subprocess type can be associated with one or more subprocess component types of a subprocess component type data artifact 830. The subprocess component type data artifact 830 can be used to assign components of a component type data artifact 834 to specific roles in a subprocess. For example, the subprocess component type data artifact 830 associates the external data-to-source data subprocess type with an input component, a processing component, and an output component, where specific components of the component type data artifact 834 are assigned to each role.

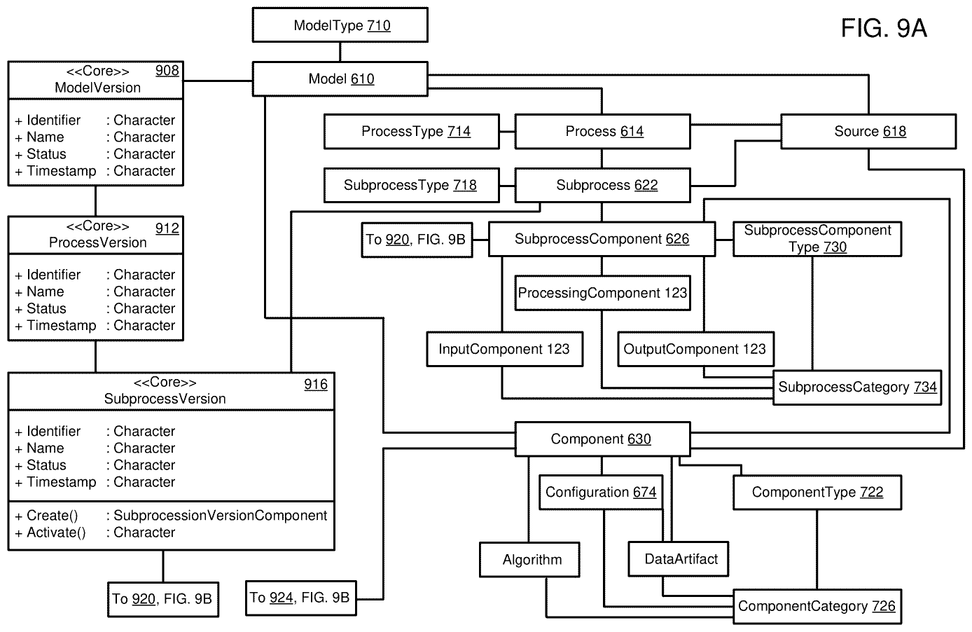

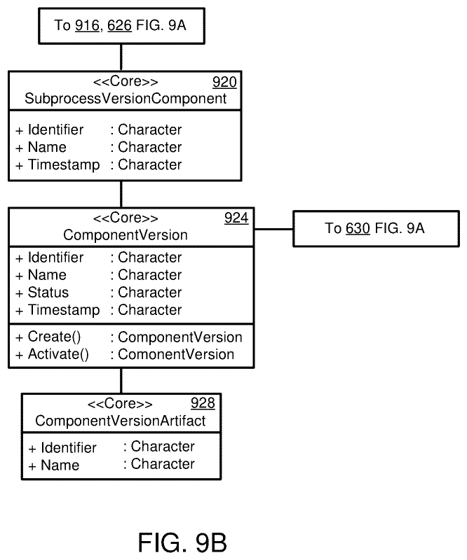

FIGS. 9A and 9B illustrate a schema 900 showing how the schema 600 of FIG. 6 and the schema 700 of FIG. 7 can be combined, along with data artifacts that provide version information. For clarity, data artifacts from FIGS. 6 and 7 retain their respective reference numbers.

In general, FIGS. 9A and 9B illustrate how models, processes, subprocesses, and components can be associated with types, and related to data artifacts providing version information. For example, the model 610 is associated with a model type 710 and a definition 908 for a model version data artifact. The definition 908 is related to a definition 912 for a process version data artifact, which in turn is related to a definition 916 for a subprocess version data artifact. Note that the definition 916 of the subprocess version data artifact includes methods to create subprocess version components and to activate subprocesses.

The subprocess data artifact 622 is associated with a subprocess type data artifact 718, as well as the definition 916 of the subprocess version data artifact. The subprocess component data artifact 626 is related to the subprocess data artifact 622 and the subprocess component type data artifact 730. Both the definition 916 of the subprocess version data artifact and the subprocess component data artifact 626 are related to a definition 920 of a subprocess version component data artifact, shown in FIG. 9B.

With continued reference to FIG. 9B, the definition 920 of the subprocess version component data artifact is related to a definition 924 of a component version data artifact, which in turn is related to a definition 928 of a component version data artifact and the component data artifact 630 of FIG. 9A.

Returning to FIG. 9A, in addition to being associated with the subprocess component type data artifact 730, the subprocess component data artifact 626 is shown as associated with a definition 940 of an input component data artifact, a definition 944 of a processing component data artifact, and a definition 948 of an output component data artifact. The data artifacts 940, 944, and 948 can serve as subclasses of the subprocess component data artifact 626. The data artifacts 940, 944, 948 are also associated with a subprocess category data artifact 734, which is also associated with the subprocess component type data artifact 730.

The model 610 is associated with the component data artifact 630, where the component data artifact is associated with the definition 924 of the component version data artifact of FIG. 9B. The model 610 is associated with the data artifact 618 for a source, where the source data artifact is also associated with the component data artifact 630, the subprocess data artifact 622, and the process data artifact 614. The component data artifact 630 is also associated with a component type data artifact 722 and can be associated with an algorithm data artifact 970, a configuration data artifact 974, or a component version data artifact 928. The data artifacts 970, 974, and 978 can serve as subclasses of the component data artifact 630. The data artifacts 970, 974, and 978 are associated with a component category data artifact 726, which is also associated with the component type data artifact 722.

### EXAMPLE 7

### Example Core, Taxonomy, and Domain Models and Relationships Therebetween, and Example Domain Model Instances

Described techniques can include associating ingested data with a semantic context, such as by representing the data in a knowledge graph or otherwise associating it with a contextual schema.

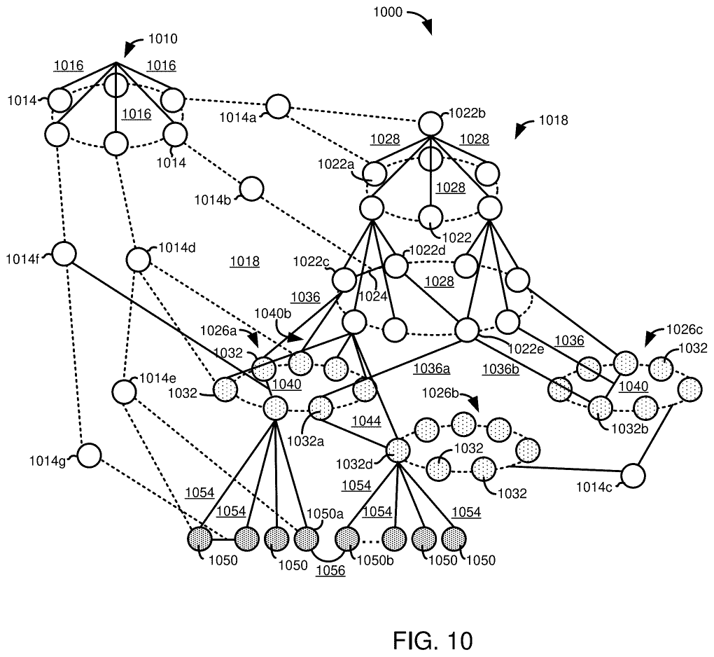

FIG. 10 illustrates a modeling environment 1000 that depicts how a core data model can relate to a taxonomy model, where the core model and the taxonomy model can be related to one or more domain models. In turn, instances, such as instances of classes in a knowledge graph and their associated properties, can be associated with elements of the core data model and one or more domain models.

The computing environment provides a core data model 1010, having core nodes 1014 (empty circles). Core nodes 1014 of the core data model 1010 represent particular organizing concepts for a schema, such as a knowledge graph. In this case, the core nodes 1014 include a node 1014a that represents a stereotype. A stereotype refers to a generalizable and reusable template or archetype within the core data model that defines a conceptual structure or behavior that can be realized or instantiated in other models. For example, a stereotype in the core data model 1010 might represent a high-level organizational concept, such as “entity,” “attribute,” or “relationship type,” which can be specialized or instantiated as specific nodes and relationships in the taxonomy model or domain models. These realizations allow for consistent application of semantic concepts across different layers of the modeling framework.

At least some nodes 1022 of a taxonomy model 1018 can be realizations of a stereotype, such as nodes 1022a, 1022b. The core nodes 1014 include a relationship type node 1014b, which defines a particular type of relationship between nodes 1022 of the taxonomy model 1018, such as a relationship 1024 between nodes 1022c and 1022d. An example relationship type can be “property of,” such as when one node in the relationship corresponds to a class and another node is a property of the class.

Nodes 1014 of the core data model 1010 can also provide organizational classifications for nodes of domain models, where FIG. 10 includes domain models 1026a, 1026b, and 1026c. The core data model 1010, the taxonomy model 1018, and the domain models 1026a-1026c can be implemented in a number of ways, but in a particular example, they are implemented as a knowledge graph.

To help understand FIG. 10, it can be useful to consider the nodes of a given model with respect to elements of a relational database data model. The core data model 1010 can provide basic organizational components, such as defining concepts of tables, columns, and relationships between tables and columns. The taxonomy model 1018 can represent standardized semantic concepts and relationships, such as particular table names and particular attributes that are available for use in a table, or provide additional details regarding structural components of the core data model 1010, such as particular table or column types.

A domain model 1026 is a specific realization of at least a portion of the taxonomy model 1018, where names of nodes and relationships may differ from those used in the taxonomy model, but where links between nodes of the taxonomy model and nodes of the domain model allow domain models to be mapped to the standardized taxonomy of the taxonomy model.

Some nodes of the taxonomy model 1018 or a domain model 1026 can represent data objects, such as tables or views. Other nodes can represent attributes (columns/fields) of the tables or views and are modeled as classes. A foreign key relationship between two database tables can be an example of a type of relationship between nodes.

The core nodes 1014 are related by core edges 1016. The core edges 1016 define particular types of relations between a pair of connected core nodes 1014. Although the core data model 1010 is shown as having a single core edge 1016 between any pair of connected core nodes, in at least some implementations multiple core edges can exist between a pair of core nodes.

The core edges 1016 help define how the core nodes 1014, and their associated semantic concepts, can be used to produce a data model that can be implemented in a computing system. The core edges 1016 can also be used to describe hierarchical relations between core nodes 1014, where a hierarchical relation can also be used in defining more complex modeling concepts from the core nodes.

The taxonomy model 1018 can be structured in a similar manner to the core model 1010, in that nodes 1022 of the taxonomy model can be connected by taxonomy edges 1028. For simplicity, not all relationships between taxonomy nodes 1022 are shown in FIG. 10. Continuing the example of the taxonomy nodes 1022 and taxonomy edges 1028, or the nodes and edges of a domain model being useable to represent a data model of a relational database, one node can represent a table, and other nodes can represent attributes. A complete table can be defined by relating the node representing the table to the nodes representing attributes using edges of a suitable relation type. For example, a node representing the table can be linked to the taxonomy nodes representing its attributes using an edge of type “has attribute” or “has component.”

Note that relations between nodes can be expressed from the “point of view” of either node. Using the previous example, the nodes representing table attributes can be related to the node representing the table using an edge of type “attribute of” or “component of.” A relation in one direction between nodes can be referred to as a “relation” (which can also be referred to as a “relationship” or a “predicate”), while the relation considered in the other direction can be referred to as an “inverse relation” (or “inverse relationship” or “inverse predicate”). A given relation or inverse relation can represent an instance of a particular relation type.

As described, a domain model 1026 represents a particular implementation of at least a portion of the taxonomy nodes 1022 of the taxonomy model 1018, and their associated relations (including as indicated by taxonomy edges 1028). The domain models 1026 are shown as including domain nodes 1032. In at least some implementations, relations between domain nodes 1032, at least within a given domain model 1026, are not expressed using edges between domain nodes. Rather, edges 1036 link a domain node 1032 with its corresponding taxonomy node 1022. Relations between domain nodes 1032 can be determined by analyzing the taxonomy edges 1028 that exist between a pair of taxonomy nodes 1022 that are linked to the domain nodes by their corresponding edges 1036. In other cases, edges 1040 can be used to directly link domain nodes 1032 of a domain 1026, where the edges can be optionally linked (via edges 1036) to corresponding taxonomy model edges 1028.

FIG. 10 illustrates how domain nodes 1032 from multiple domain models 1026 can be linked to a common node 1022 of the taxonomy model 1018. For example, edges 1036a and 1036b link domain nodes 1032 a and 1032 b to taxonomy node 1022 e. In practice, many domain nodes 1032 from multiple domain models 1026 will be linked to common taxonomy nodes 1022. The single common taxonomy node 1022a is shown for simplicity of presentation.

As an example of relations between domain nodes 1032 of different domain models 1026, consider that a node in a first domain represents a “business process” and has a relation to a corresponding taxonomy node 1022. A second domain may include a domain node 1032 that contains a “process element” node that is linked to the same taxonomy node 1022 as the domain node of the first domain. Thus, the domain nodes 1032 of the first and second domain models 1026 can represent the same semantic concept, in the form of taxonomy node 1022.

In addition to, or in place of, relating domain nodes 1032 of different domains 1026 through a taxonomy node 1022, domain nodes of different domains can be directedly related, such as using edges 1044. Since the taxonomy model 1018 represents general semantic concepts that are represented in different domain models 1026, the taxonomy data model may not be “aware” that different domains exist, or at least that two domain models have a more direct relationship.

The concept of “derivatives” was discussed earlier. A derivative can be used to express that a domain node 1032 is a realization of a taxonomy node 1026. The term derivative can also be used to indicate that related domain notes 1032 of different domains refer to the same semantic concept, or instances thereof.

One or more instances 1050 of a domain node 1032 can be created and are related to the domain nodes via edges 1054. Instances 1050 are specific to a particular domain node 1032 and therefore specific to a particular domain model 1026. Note that relations can also be established between domain instance nodes 1050. For example, a node 1050a in a first domain can represent a business process of “accrual management,” while a node 1050b in a second domain can have a process element “manage accruals” with a similar meaning. Relations between domain instance nodes 1050 can be represented as edges, in a similar manner as the edges 1030, 1036, and 1040, as shown by an edge 1056.

FIG. 10 provides additional examples of how core nodes 1014 can be linked to nodes of other models, or instances of domain models. For example, node 1014c represents a concept of a domain and can be linked to the domains 1026. A core node 1014d represents a type, which is realized by domain nodes 1032, and a core node 1014e representing instances of types, which are realized by instances 1050. A core node 1014f represents relations between domain nodes 1032, while a core node 1014g represents relations between instances.

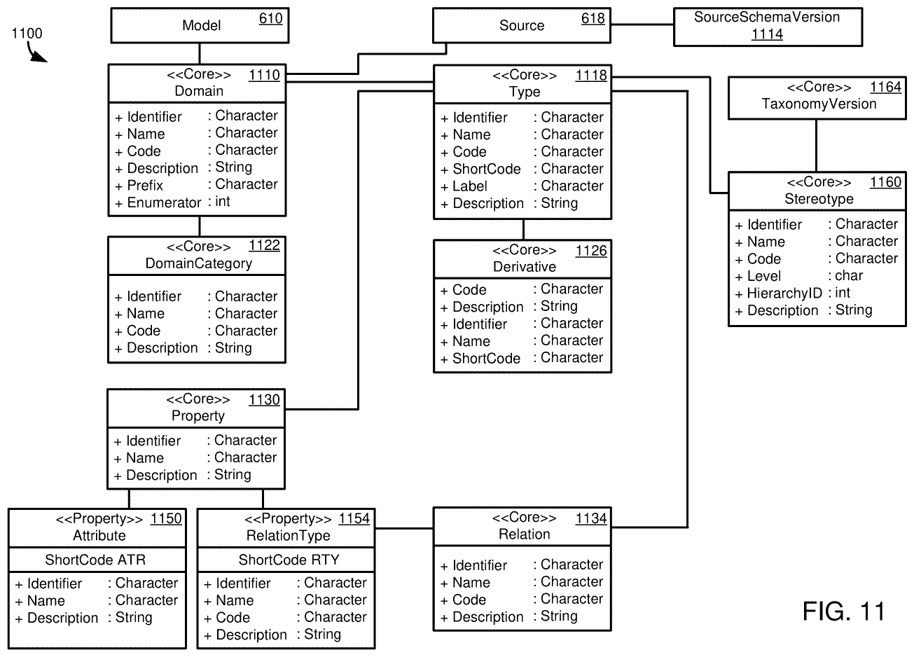

FIG. 11 provides an example schema 1100 that illustrates elements of the modeling environment 1000 of FIG. 10 and their interactions. The schema 1100 includes a model data artifact 610 and a source data artifact 618, as described with respect to FIG. 6. These data artifacts are each associated with a domain data artifact 1110, which represents a specific realization of at least part of a taxonomy model. The source data artifact 618 is further linked to a source schema version data artifact 1114, capturing the evolution of schemas over time. This versioning supports the ability to map changing schema elements to consistent semantic standards in the taxonomy model.

The domain data artifact 1110 is associated with a type data artifact 1118 and a domain category data artifact 1122. The type data artifact 1118 serves as an abstract organizing construct derived from the core data model and is further associated with a derivative data artifact 1126, reflecting its dynamic adaptation to support schema mappings or transformations. The type data artifact 1118 also defines structural relationships to a property data artifact 1130 and a relation data artifact 1134, which are additional constructs derived from the core model. For example, properties can represent attributes or characteristics of a domain concept, while relations define specific interactions or dependencies between domain elements. The domain model is linked to the taxonomy model through a relationship between the type data artifact 1118 (a taxonomy model artifact) and a stereotype data artifact 1160 (also a taxonomy model artifact), where the stereotype data artifact is further associated with a taxonomy version data artifact 1164.

The schema 1100 also illustrates how a taxonomy model interacts with the core data model. The taxonomy model extends the core model by introducing taxonomy-specific artifacts, such as an attribute data artifact 1150 and a relation type data artifact 1154, which are linked to the property data artifact 1130 and the relation data artifact 1134, respectively. These data artifacts refine the structural elements defined in the core model to support standardized and reusable schema components. For example, an attribute data artifact may represent a specific attribute structure used across multiple domains, while a relation type artifact defines standardized relationships, such as “belongs to” or “is part of,” that can be applied universally.

The taxonomy model further incorporates semantic concepts that standardize domain-independent representations of schema elements. For instance, the taxonomy model may define a concept like “order,” which serves as a semantic anchor for mapping domain-specific elements from different source schemas. For example, a domain-specific “purchase order” or “sales order” can be mapped to the standardized “order” element in the taxonomy model. This mapping provides consistency across domains while enabling semantic alignment.

The source schema is dynamically mapped to the taxonomy model, with its domain-specific elements linked to corresponding taxonomy artifacts through derivatives and other mappings. For instance, a source schema version might define specific data structures, such as “customer_id” or “order_date,” which are linked to standardized concepts in the taxonomy model like “Customer” or “Order Date.” The taxonomy model allows these mappings to remain consistent even as source schemas evolve over time, supported by schema versioning mechanisms.

The core data model continues to provide the foundational structure underlying both the taxonomy model and the domain models. The core model includes constructs like type, property, and relation, which are refined in the taxonomy model and further instantiated in the domain models. For example, a domain model 1110 may define a specific realization of taxonomy elements, such as an enterprise-specific schema for “Customer Data,” which maps its elements back to the taxonomy model for consistency and interoperability.

FIG. 11 demonstrates the interplay between the core mode, the taxonomy model, and domain models, illustrating how elements of each layer support schema mapping, alignment, and standardization. The taxonomy model's dual role as a structural extension of the core model and as a semantic framework for domain alignment enables the integration of diverse schemas and supports evolving source schemas through versioned mappings.

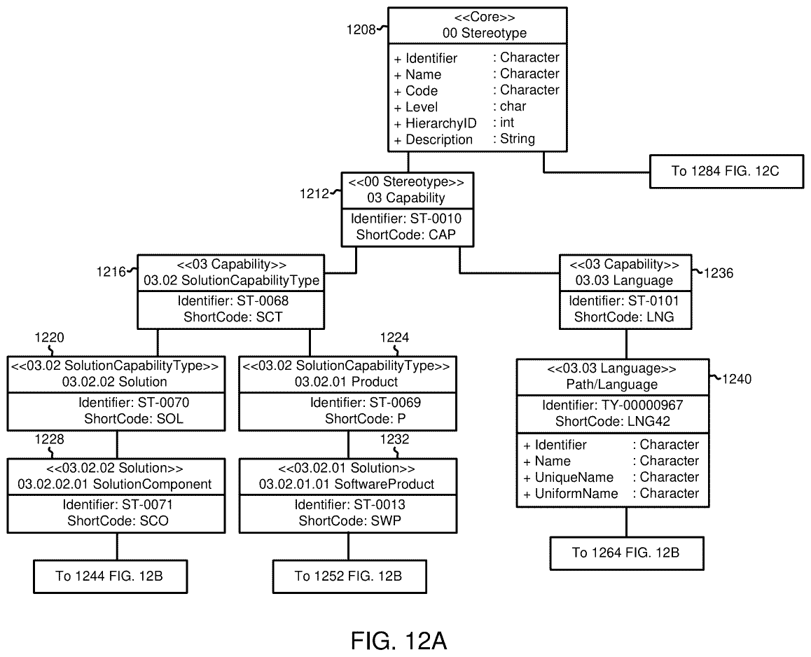

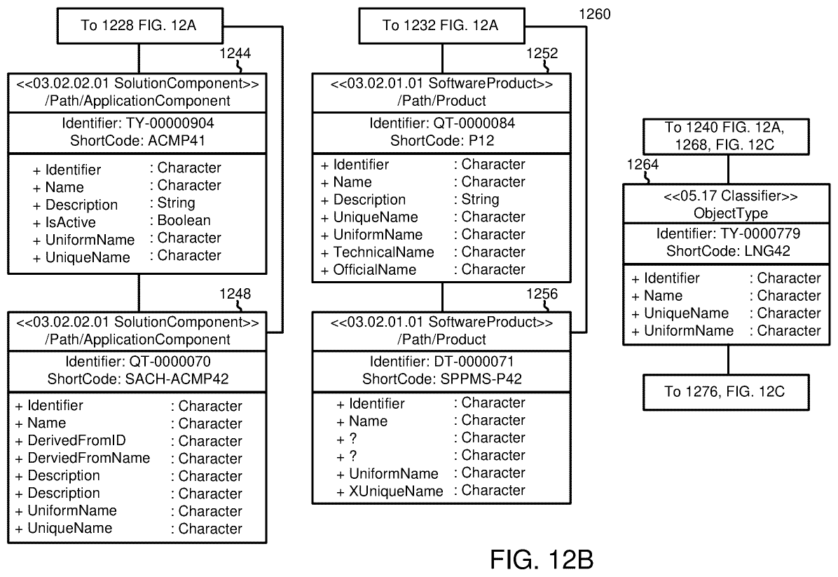

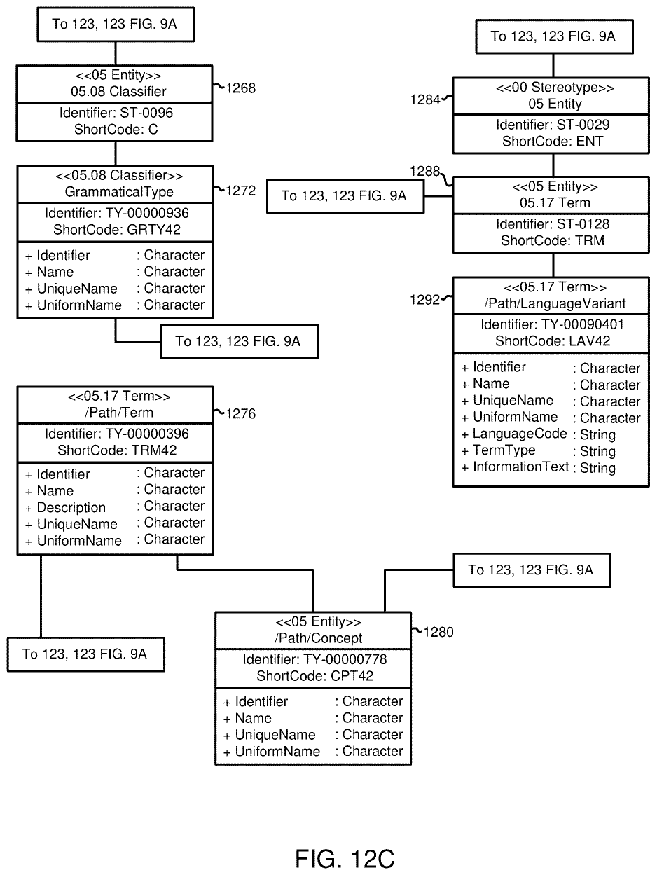

FIGS. 12A-12C illustrate an example data model 1200 organized according to the modeling environment 1000 that associates ingested data with semantic information. For example, the source data artifact 618 and the model artifact 610 of FIG. 6 can be associated with a domain, where the domain is linked to a semantic model, such as a knowledge graph, which may include an associated ontology.

In the data model 1200, artifact 1208 corresponds to a node of the core data model 1010 of FIG. 10. Data artifacts 1212, 1216, 1220, 1224, 1228, 1232, 1268, and 1284 correspond to nodes of the taxonomy model 1018 of FIG. 10, representing standardized semantic concepts and structural extensions of the core model. Data artifacts 1240, 1244, 1252, 1264, 1272, 1276, 1280, and 1292 correspond to nodes of a domain model 1026 of FIG. 10, representing domain-specific implementations of taxonomy elements. Data artifacts 1248 and 1256 also correspond to a domain model 1026 of FIG. 10 but are part of a different domain than the domain associated with data artifacts 1240, 1252, and 1264. Linking data artifacts from different domains facilitates the alignment of common semantic concepts and enables operations such as associating data in one domain with data in another.

The term “derivative” is used to describe relationships in two complementary contexts. First, a derivative represents the relationship between a source schema and the local schema (taxonomy model), capturing the semantic mapping of domain-specific constructs in the source schema to standardized elements in the taxonomy model. For example, a source schema element like “sales order” can be mapped to the standardized semantic concept “order” in the taxonomy model through a derivative relationship. Second, a derivative describes relationships between artifacts in different domains that share a common semantic concept. For example, domain-specific representations of “customer” in two different domain models may be linked as derivatives, reflecting their shared mapping to the standardized “customer” concept in the taxonomy model.

Additionally, the derivative concept provides significant benefits when relating data from two different sources. By reusing data from one source in the context of another source, the second source can add new properties or relations to the original data, enriching its context and usability. This approach supports the decoupling of data from different sources, allowing each source to maintain its integrity while enabling the mapping of corresponding entities. For example, in FIG. 12B, the entity represented by 1244 with ShortCode ACMP41 is reused in another source, represented by 1248 with ShortCode SACH-ACMP42. The second source adds properties or relations to the instances from the original source, facilitating comprehensive data integration and enhancing the ability to perform cross-source analytics and reporting.

The derivative concept is also applicable within the same source, particularly when different subgraphs are created from the same source data at different times or under different conditions. This is especially useful for tracking relationships between data ingested using different processes. For example, data from the same source might be processed using different ingestion pipelines, resulting in subgraphs that reflect various transformations or enhancements. The derivative relationship can link instances across these subgraphs, maintaining a clear lineage of how data has evolved through different processing stages. For instance, a subgraph created using one process might contain an instance of a product with certain properties, while another subgraph created using a different process contains an updated instance of the same product with additional properties or relations. The derivative relationship allows these instances to be linked, reflecting their evolution and supporting consistent data usage. This approach enhances traceability, consistency, and integration within the same source, making it easier to manage and analyze data over time.

### EXAMPLE 8

### Example Events During Process Execution or in Response to Changes to Process Definitions

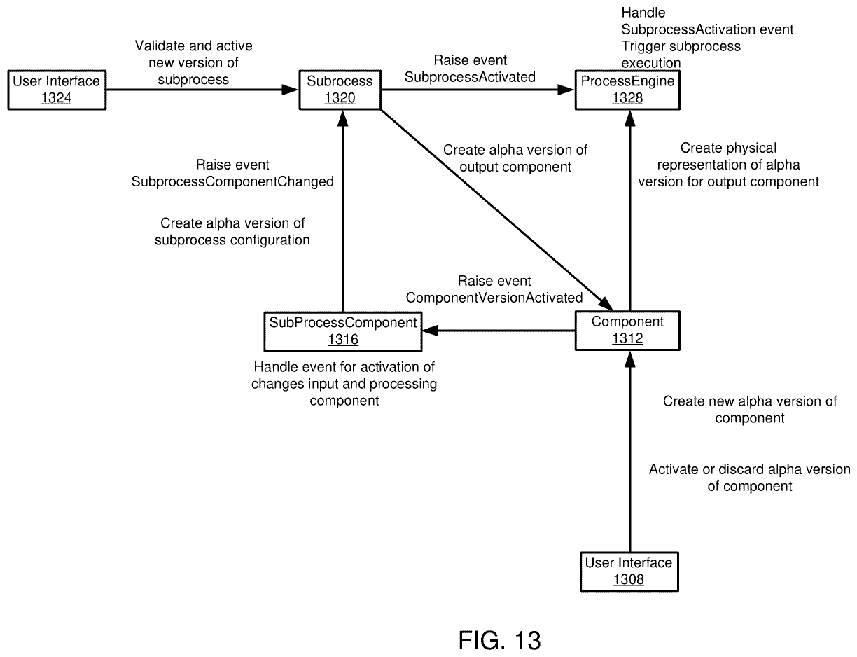

FIG. 13 provides a diagram that illustrates how various operations with respect to a model and its elements, such as subprocesses or components, can trigger various events, including events that affect versioning of model components.

Through a user interface (UI) 1308, a user can perform actions such as validating alpha versions of components 1312, including a new version of an algorithm or an input or output data artifact. In response to the validation, the user can choose to activate or discard the alpha version of the component 1312. Activating the component 1312 causes an event to be raised. The event can be handled with respect to a subprocess component 1316. Thus, a change to a component 1312 results in events affecting subprocesses that use that component. Since multiple subprocesses can use the same component 1312, a change to a component can cause multiple events to be raised, corresponding to subprocesses in which the component is used.

As part of handling the event for the activated component 1312 in relation to the subprocess, an event can be raised that indicates a change to a subprocess component. In response, an alpha version of a subprocess 1320 can be generated. Again, since the same component 1312 can be used by multiple subprocess, a change to a component, and therefore to a subprocess component, can result in multiple events being raised to create alpha subprocess versions.

Through a user interface 1324, which can be the same as the user interface 1308 or different, a user can select to validate and optionally activate the new version of the subprocess 1320. If the user activates the alpha version of the subprocess 1320, an event can be raised to the process engine 1328. The process engine 1328 can, in response to the event, trigger execution of the subprocess. The execution produces a physical representation of an alpha version of an output component. Note that as part of the event indicating that a subprocess component has changed, a new version of the output component 1312 can be created, which can store execution results of the process engine 1328. This means changing a component 1312 can change not just the directly changed components, but other components indirectly. For example, a change to a component 1312, such as an algorithm, results in a new version of that component, but, since the output will now be different from output generated using the older version of the component, a new output component is also generated.

### EXAMPLE 9

### Example Matcher for Matching Data Between Source Schemas

The present disclosure provides techniques and solutions that can be used to match particular data associated with a source schema to one or more target schemas. For example, the matching technique can be used to match data between data sets, which may be associated with the same source schema or different source schemas, where the data in the data sets has also been correlated with a common schema, such as a local schema. These techniques and solutions can be used with the technology discussed in Examples 2-8, which describe tracking of changes to processes and triggering actions in response. However, the disclosed matching techniques can be used in other contexts.

Since the matching techniques can be used alongside the change tracking techniques, they will be described herein in the context of the processes, models, and sources previously described. However, the specific performance of the matching, and its potential applications, can occur via other types of processes, making these techniques broadly applicable for analyzing source data to determine matches with a schema.

Generally, the matcher associates data that has been ingested from a source and processed with respect to one semantic model with another semantic model. Elements of the semantic models, as well as corresponding data, can be linked through derivative relationships as outlined with respect to FIGS. 10 and 11. The matcher extends this functionality by identifying and reconciling relationships dynamically between subgraphs aligned to a local schema, providing flexible data integration and alignment.

The matcher serves as a dynamic component for reconciling data between subgraphs that have been semantically aligned to a local schema through the subgraph-to-derivative process. Unlike the deterministic operations of the subgraph-to-derivative process, which typically rely on predefined mappings between a source schema and the local schema (e.g. based on identifiers), the matcher operates probabilistically. It leverages patterns learned during training to identify relationships or equivalences between data points across subgraphs. By evaluating features derived from subgraph elements, including validated alignments to the local schema, their attributes, and their structural or semantic context, the matcher dynamically determines how subgraph elements of different subgraphs correspond to one another.

In the context of the source-to-graph process, during the training phase, the matcher is trained on data derived from the subgraph-to-derivative process. This training data includes labeled examples pairing elements from a source schema subgraph with corresponding elements in the local schema. Through this training, the matcher learns to generalize alignment patterns, enabling it to infer relationships during inference. For instance, if a subgraph element representing user.name=“John Doe” aligns with localSchema.person.name, the matcher may infer that another subgraph element, such as customer.name=“J. Doe”, also aligns with localSchema.person.name, even in the absence of explicit training examples for that relationship.

During inference, the matcher evaluates relationships between data elements from one subgraph and potential candidates from another subgraph, leveraging their shared alignment to the local schema. This process significantly narrows the search space, as only subgraph elements aligned to the same local schema entity are considered for potential matches. For example, subgraph elements aligned to localSchema. person are evaluated to determine whether a new subgraph element should be matched to an existing instance or added as a new instance in the target subgraph. The matcher assesses these relationships based on features such as semantic similarity (e.g., textual embeddings, categorical values), structural context (e.g., parent-child relationships or graph connectivity), and instance-specific attributes (e.g., numerical differences or derived statistics).

The matcher can operate at two levels: instance-to-instance reconciliation and schema-level alignment. For instance-to-instance reconciliation, the matcher determines whether data elements from one subgraph represent the same real-world entity as elements in another subgraph, enabling the consolidation or linkage of equivalent data. For schema-level alignment, the matcher may dynamically infer the placement of new data within the target schema when no equivalent instance exists, thereby creating new instances under the appropriate semantic element. The matcher's output typically includes metadata linking data elements across subgraphs, such as isEquivalentTo relationships for matched instances or isDerivedFrom relationships for new instances added to the target subgraph. The matching process encompasses various types of operations that align data from a source model with corresponding elements in a target model. The primary types of matching include instance-to-instance matching, semantic mapping of conceptual elements, and enrichment of the target model with data from the source model when direct matches are unavailable.

Instance-to-instance matching involves identifying specific correspondences between individual data instances in the source model and those in the target model. This form of matching is particularly useful when the source and target models contain overlapping sets of data, such as records that share common attributes or values. The determination of whether two instances match may involve comparing their attributes, such as numerical values, categorical labels, or textual descriptions. Features derived from these attributes, including similarity scores, statistical differences, or context-based metrics, can be used to determine whether a match exists. For example, if the source model contains an entry for user.name=“John Doe” and the target model contains person.fullName=“Johnathan Doe”, a combination of textual similarity and contextual features may establish that these instances represent the same individual.

When no direct instance matches are found, the process may perform semantic mapping of elements from the source model to corresponding elements in the target model.

This type of mapping aligns conceptual elements, such as schema attributes, entities, or relationships, based on their semantic or structural characteristics. For instance, the process may map a schema element in the source model, such as user. age, to a schema element in the target model, such as person.age. Semantic mapping relies on features that describe the relationships and similarities between the elements, including textual similarity (e.g., name or description matching), structural relationships (e.g., shared parent elements in a hierarchy), and domain-specific rules or constraints. Even when specific instance-level data is unavailable or insufficient to establish a match, semantic mapping facilitates the alignment of schema-level elements, providing a basis for further operations such as data transfer or transformation.

In cases where neither instance-level matching nor semantic mapping produces a definitive correspondence, the process may incorporate data from the source model into the target model to enrich its content. This enrichment involves creating new instances in the target model under appropriate semantic elements identified through the mapping process.

For example, if the source model contains user.age=35 and the target model lacks an instance corresponding to this specific user, the process may add a new instance to the target model's person age schema element with the value 35. This approach enables the target model to be augmented with new information, supporting use cases such as data integration, knowledge graph construction, or database synchronization.

Each type of matching serves a distinct purpose within the overall process and may be employed independently or in combination. Instance-to-instance matching prioritizes the alignment of specific data entries, semantic mapping focuses on conceptual and structural relationships between models, and enrichment allows for the transfer of new or additional data into the target model.

The preparation of input data for the matching process involves transforming diverse types of information into a numerical format suitable for analysis by models or algorithms. This process accommodates different attributes of the data, including textual, categorical, numerical, and structural elements, while preserving their semantic and contextual meaning. The data preparation process is designed to handle both the source and target models'features and relationships, creating a uniform representation that supports instance matching, semantic mapping, and enrichment tasks.

Textual data, such as names, descriptions, or metadata associated with elements in the source and target models, is converted into numerical representations using techniques such as embeddings. Pre-trained natural language models, such as BERT, Word2Vec, or GloVe, may be used to generate dense vector embeddings that capture semantic relationships between textual elements. These embeddings provide numerical representations in a high-dimensional space, allowing for the computation of similarity metrics, such as cosine similarity, to identify relationships between textual attributes. For example, the textual data user.name=“John Doe” in the source model and person.fullName=“Johnathan Doe” in the target model may be transformed into embeddings that reflect their semantic proximity, facilitating their comparison during the matching process.

Categorical data, such as schema names, attribute labels, or identifiers, is transformed using encoding techniques that map these categories to numerical values. One-hot encoding, which represents each category as a binary vector, is suitable for categorical attributes with a small number of unique values. For high-cardinality attributes, ordinal encoding or entity embeddings may be used to create more compact representations. Entity embeddings, which are learned during model training, allow categorical attributes to be represented as dense vectors that capture relationships between categories. For instance, a categorical attribute such as user. role with values like “admin,” “editor,” and “viewer” could be encoded into vectors reflecting their hierarchical or functional relationships.

Numerical data, such as age, height, or statistical metrics, may require preprocessing to normalize or transform the values. Normalization scales the data to a standard range, such as [0, 1], providing consistency across attributes with different scales. Alternatively, log transformations may be applied to reduce the impact of outliers or skewed distributions.

Derived features, such as differences, ratios, or aggregations, may also be computed to enhance the representation of numerical attributes. For example, given user.age=35 in the source model and person.age=30 in the target model, derived features such as the absolute difference (|35−30|=5) and the ratio (35/30=1.17) can provide additional information to the matching process.

Similarity metrics, including semantic and structural similarities, are computed for pairs of elements in the source and target models. Semantic similarity captures the conceptual relationship between elements, such as the similarity between textual descriptions or embeddings. Structural similarity reflects the relationships between elements in their respective models, such as shared parent nodes, common neighbors, or graph connectivity measures. For example, elements in a hierarchical schema may be compared based on their depth, sibling relationships, or shared ancestors, while elements in a graph-based model may be compared using metrics such as the shortest path distance or edge weights. similarities are represented as numerical features, contributing to the overall feature set used by the matching process.

Missing data can be addressed to avoid disruptions in the matching process. Missing values may be imputed using statistical methods, such as replacing missing numerical data with the mean or median of available values. For categorical or textual attributes, placeholder values may be introduced, or embeddings may be computed based on partial information. Additionally, binary indicator variables may be added to the feature set to denote whether a particular value is missing, allowing the matching process to account for this uncertainty.

The final representation of the data combines all preprocessed features into a unified numerical format. For each pair of elements being compared, a feature vector is constructed that includes transformed textual, categorical, and numerical attributes, as well as similarity metrics and derived features. This representation serves as input to the models or algorithms used in the matching process.

During the training phase of the matching process, input data may be enriched with contextual or relational information to capture structural and semantic relationships between elements in the source and target schemas. This relational data can include features derived from schema structures, such as nodes or attributes connected to a specific element within a specified degree of indirection. By incorporating such relational features, the system provides the model with additional context about the broader environment in which a node or attribute exists, enabling it to learn patterns of structural similarity or conceptual alignment across schemas.

For example, in graph-based schemas, training data for a node such as user. name in the source schema may include features derived from immediate neighbors, such as user.email or user.id, along with attributes of those neighbors, such as their data types or representative values. Additional features might include aggregated statistics from nodes within a certain radius, such as the average degree of connected nodes or the distribution of data types among related nodes. Similarly, in hierarchical schemas, training data can include positional information, such as the depth of an element within the hierarchy or its path to the root, as well as relationships to parent, sibling, or descendant elements. Shared attributes across elements, such as a common ancestor grouping user.name and user.email under the entity user, can also serve as relational features.

These contextual and relational features are encoded as numerical values or embeddings during training and combined with other features derived from the attributes of the element itself, such as textual descriptions or instance values.

During inference, relational data used in training is not required. Instead, the model operates on the immediate input data and its associated semantic element in the source schema. For instance, given input data such as John Doe associated with the semantic element user.name, the model predicts the alignment to a target schema based on patterns learned during training, without needing explicit access to the extended relational features.

The structural and contextual relationships captured during training are effectively encoded within the model's parameters, allowing it to generalize these patterns to unseen data or schemas.

This separation between training and inference simplifies the deployment of the matching process. By leveraging relational features during training, the model gains the capacity to understand structural relationships without requiring runtime access to such data. For example, during training, the model may observe relationships such as user.name aligning with person.fullName due to shared parent nodes (user and person) or sibling nodes (user.email and person.email). At inference, the model applies this knowledge to predict alignments for new data under user.name without requiring real-time computation or retrieval of these relational features. This approach allows the system to remain efficient during inference while benefiting from rich contextual information during training.

The matching process may be implemented using a variety of models and algorithms. The selection of models or algorithms depends on the complexity of the data, the relationships being evaluated, and the specific requirements of the application.

Supervised machine learning models can be used, particularly when labeled training data is available. These models are trained to classify or score pairs of elements from the source and target models based on their likelihood of being a match. A typical implementation might involve a decision tree, random forest, gradient-boosted machine, or support vector machine. The features provided to these models include numerical representations of textual, categorical, and numerical attributes, as well as derived features and similarity metrics. For example, a pair of elements with a high semantic similarity score and a small numerical difference in attribute values might be assigned a high probability of being a match. The outputs of such models may be binary classifications indicating whether a match exists or continuous scores reflecting the degree of confidence in the match.

Neural networks, particularly those designed for structured data, can also be used. A feedforward neural network, for instance, can be used to process feature vectors derived from pairs of elements, applying non-linear transformations to capture complex relationships. These networks can be further enhanced with specialized architectures tailored to the data type. For example, a convolutional neural network (CNN) might be used to analyze spatially organized features, such as embeddings representing positional or structural relationships in a graph. Recurrent neural networks (RNNs) or their modern derivatives, such as long short-term memory networks (LSTMs), can handle sequential data, capturing temporal or hierarchical relationships between elements.

Embedding-based methods focus on transforming elements of the source and target models into vector representations in a high-dimensional space, where the proximity of vectors reflects the similarity of the corresponding elements. These embeddings, generated using pre-trained models such as BERT, Word2Vec, or graph-specific embeddings like TransE or DistMult, capture semantic and relational information. Matching is performed by comparing these embeddings using distance metrics such as cosine similarity, Euclidean distance, or Manhattan distance. For instance, textual data associated with source and target instances may be transformed into embeddings that reflect their semantic proximity, facilitating accurate comparisons.

Neural language models based on transformer architectures, such as BERT or GPT, extend the capabilities of embedding-based methods by incorporating contextual information. These models use self-attention mechanisms to capture relationships between data attributes and their broader context, enabling enhanced semantic understanding. Transformers can process textual data to generate contextual embeddings, compute semantic similarities, and infer mappings between schema elements. For example, transformers may be fine-tuned on labeled datasets to classify whether a source instance corresponds to an existing target instance or to predict the appropriate semantic class for new instance addition. These embeddings can further be combined with relational features, such as structural information, to improve the performance of the matching process.

Graph neural networks (GNNs) can be used for tasks involving graph-structured data, such as knowledge graphs or schemas with complex interdependencies. By propagating features through the graph, a GNN aggregates information from neighboring nodes and edges to compute context-aware representations of each node or element. These representations capture both the intrinsic properties of the nodes and their relationships within the graph, allowing for nuanced comparisons between elements. For instance, a GNN may analyze a node in the source graph representing a user and its connections to other entities, such as roles or transactions, to determine its correspondence to a node in the target graph representing a person. GNNs can therefore be used for both instance-to-instance matching and semantic mapping tasks within graph-based models.

Rule-based models provide an alternative or complementary approach, relying on explicitly defined criteria to determine matches. These systems may use deterministic rules, such as exact equality of certain attributes or thresholds for numerical differences, to identify matches. For instance, a rule might specify that two instances are considered a match if their names are identical and their ages differ by less than five years. While rule-based systems can be difficult to use with complex schemas, they can be useful for establishing baseline matches or handling cases where the matching criteria are well-defined and straightforward.

Hybrid approaches combine the strengths of multiple models or algorithms to enhance the accuracy and robustness of the matching process. For example, a rule-based model can be used to filter obvious non-matches, reducing the number of comparisons required by a machine learning classifier or embedding-based similarity measure. Alternatively, embeddings might be used to compute coarse similarities, which are then refined by a neural network trained to evaluate fine-grained relationships.

These models and algorithms can be further optimized through techniques such as active learning, which prioritizes the labeling of uncertain or high-impact training examples, or transfer learning, where pre-trained models are fine-tuned for the specific domain of the matching task.

In particular implementations, such as when using versioned processes, subprocesses, and components as part of an ingestion pipeline, the process of identifying training data, training the matcher, creating matches, and validating matches is subject to the same data-to-algorithm dependency, or dependency on another type of component or process or subprocess definition, that is addressed for the previously explained data transformation subprocess. This dependency underscores the importance of the quality and relevance of the training data in determining the effectiveness of the matching algorithm.

Furthermore, the relationship between the data and the quality of the matcher algorithm is dynamic. This dynamic nature provides that continuous retraining can be useful to adapt to new data and evolving requirements. This ongoing retraining is managed through the event management capabilities of the framework, which facilitate the continuous improvement of the matcher by incorporating new or updated training data as it becomes available. This approach helps maintain the accuracy and effectiveness of the matcher over time.

The modular and extensible nature of the framework plays a significant role in supporting this continuous improvement. The framework's design allows for the seamless integration of new components and algorithms, making it adaptable to changing data and requirements. This modularity also simplifies the validation and deployment of updated matchers, enabling the system to evolve and improve without significant disruptions.

### EXAMPLE 10

### Examples Computing Environment With Matcher and Matcher Trainer

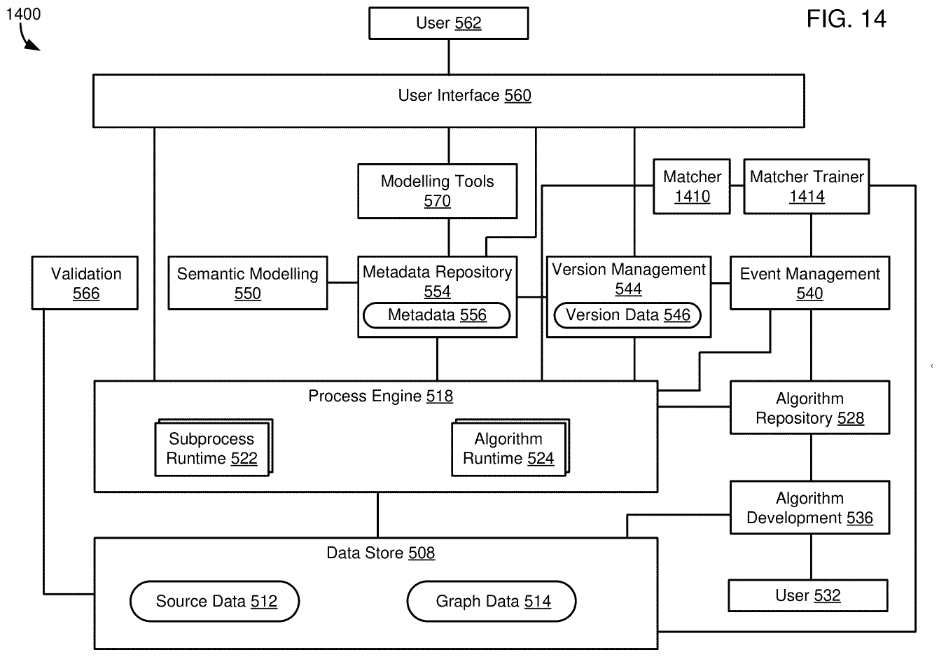

FIG. 14 is a diagram of a computing environment 1400 in which disclosed techniques can be implemented. FIG. 14 closely resembles FIG. 5, and components in both figures retain the same reference numbers as in FIG. 5. The computing environment 1400 further includes a matcher 1410. As described, the matcher 1410 can be called, such as by the process engine 518, to identify possible matches between data from one source schema being processed and one or more other source schemas, where both source schemas are mapped to a local schema.

The computing environment 1400 also includes a matcher trainer 1414. The matcher trainer 1414 is responsible for training the matcher 1410, including performing additional training as validated matches are confirmed, such during a process performed by the process engine 518 that matches data associated with a source schema to a local schema. For example, when data has been processed by the process engine 518, the event management component 540 can raise an event to let the matcher trainer 1414 know that new data is available. The matcher trainer 1414 can then use the data to perform additional training of the matcher 1410.

### EXAMPLE 11

### Examples Source Data to Graph Process Including Matcher Operations

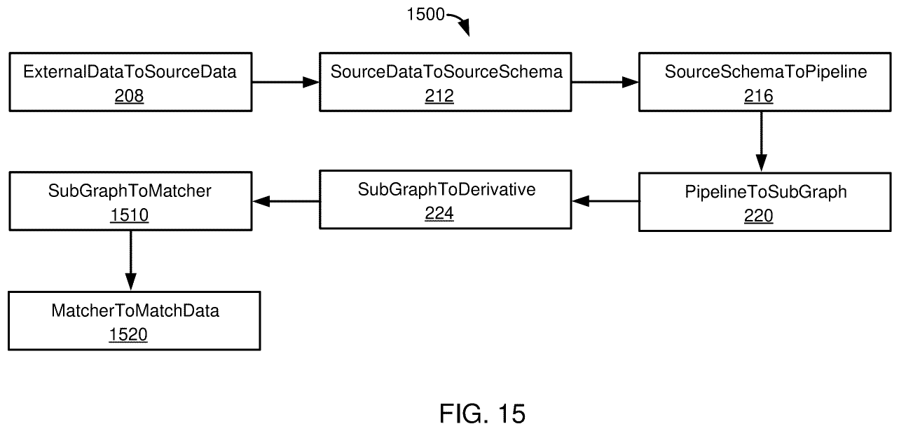

FIG. 15 illustrates a process 1500 that extends the process 200 of FIG. 2. Steps shared between processes 200 and 1500 retain the reference numbers of FIG. 2. Using a subgraph produced by the pipeline to derivative operation 224, the process 1500 includes a subgraph to matcher operation 1510. The subgraph to matcher operation 1510 can be used to train a matcher, as described above, which can, for example, correlate data between different subgraphs, whether from the same source schema or from different source schemas. The SubGraphToDerivative operation 224 maps data from a given source schema to a local schema, producing validated relationships and alignments. The SubGraphToMatcher operation 1510 uses these validated results to train the matcher. The matcher can then be applied in a matcher to match data process 1520 to determine whether data from one subgraph can be added to, or matched with, data in another subgraph. The output of the matcher to match data process can include metadata that links data from one subgraph to another subgraph, such as instance-level equivalences or semantic relationships.

### EXAMPLE 12

### Example Schema Implementation for Process with Matcher and Mather Trainer Implemented Subprocesses

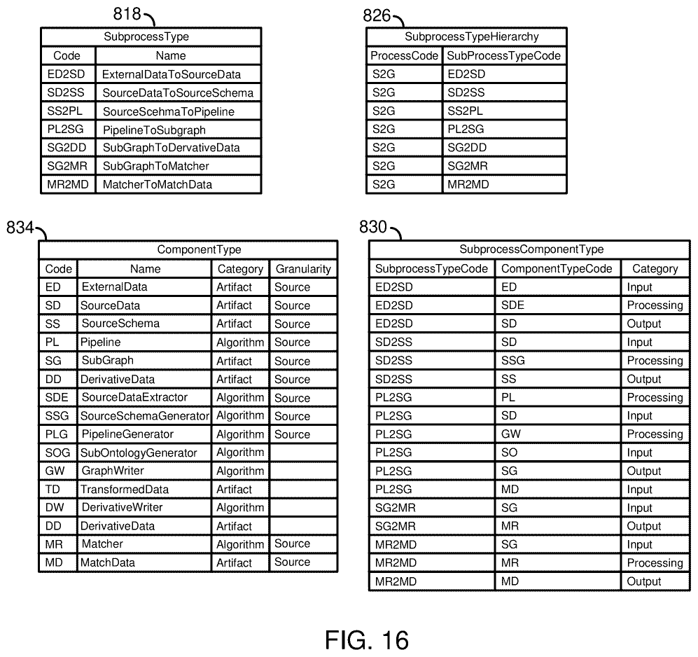

FIG. 16 provides a schema implementation 1600 that is generally similar to the schema implementation of FIG. 8, where FIG. 16 uses the reference numbers from FIG. 8. The data artifacts 818, 826, 830, 834 include components corresponding to a matching process and a process to train a matcher. The subprocess type data artifact 818 includes a subgraph to matcher subprocess and a matcher to match data subprocess. These processes are also included in the subprocess type hierarchy data artifact 826. The subprocess component type data artifact 830 identifies input, output, and processing components for subprocesses of the subprocess type data artifact 818. The component type data artifact 834 identifies types of components used for matching or matcher training subprocesses, such as a matcher, an algorithm, and match data, which is a data artifact.

### EXAMPLE 13

### Examples Operations

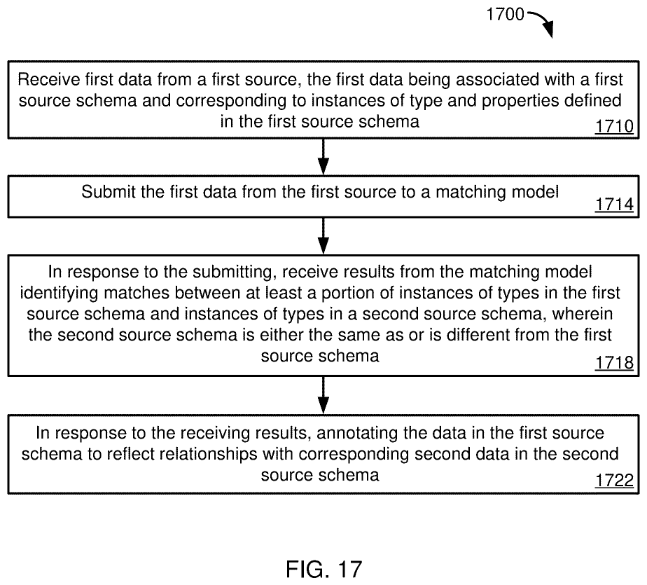

FIG. 17 illustrates a flowchart of a process 1700 for processing and annotating data. At 1710, first data is received from a first source. The first data is associated with a first source schema and corresponds to instances of types and properties defined in the first source schema. Data from the first data source is submitted to a matching model at 1714. At 1718, in response to the submission, results are received from the matching model. The results identify matches between at least a portion of instances of types in the first source schema and instances of types in a second source schema, where the second source schema is either the same as or different from the first source schema. At 1722, in response to receiving the results, the data in the first source schema is annotated to reflect relationships with corresponding second data in the second source schema.

### EXAMPLE 14

### Additional Examples

Example 1 is a computing system that includes at least one hardware processor, at least one memory coupled to the hardware processor, and one or more computer-readable storage media. The computer-readable storage media include computer-executable instructions that, when executed, cause the computing system to perform operations. The operations include receiving first data from a first source. The first data is associated with a first source schema and corresponds to instances of types and properties defined in the first source schema.

The operations further include submitting the first data from the first source to a matching model. In response to the submission, results are received from the matching model. The results identify matches between at least a portion of instances of types in the first source schema and instances of types in a second source schema, where the second source schema is either the same as or different from the first source schema. In response to receiving the results, the data in the first source schema is annotated to reflect relationships with corresponding second data in the second source schema.

Example 2 is the computing system of Example 1, where the second source is the first source.

Example 3 is the computing system of Example 1, where the second source is different from the first source.

Example 4 is the computing system of any of Examples 1-3, where the second schema is different from the first schema.

Example 5 is the computing system of any of Examples 1-3, where the second schema is the same as the first schema.

Example 6 is the computing system of any of Examples 1-5, where the annotating includes establishing that an instance of a type in one of the first source schema or the second source schema is derived from an instance of a type in the other source schema.

Example 7 is the computing system of Example 6, where the first source schema and the second source schema are implemented as knowledge graphs, and the establishing of the derivation comprises assigning a predicate to a relationship between the instances, the predicate indicating a derivation relationship.

Example 8 is the computing system of any of Examples 1-7, where the annotating is performed as part of a process of ingesting the first data from the first source, and the second data comprises data ingested from the second source.

Example 9 is the computing system of any of Examples 1-8, where the operations further include training the matching model using data annotated as part of the annotating.

Example 10 is the computing system of Example 9, where the operations further include generating an event indicating that the matching model has received additional training.

Example 11 is the computing system of Example 10, where the operations further include, in response to generating the event, reprocessing previously ingested data using an updated version of the matching model.

Example 12 is the computing system of Example 10 or Example 11, where the operations further include generating a new version identifier for the matching model in response to the additional training.

Example 13 is the computing system of any of Examples 1-12, where the operations further include annotating data in the first source schema with an identifier of a version of the matching model used in generating the results.

Example 14 is a method implemented in a computing system that includes at least one hardware processor and at least one memory coupled to the hardware processor. The method includes receiving first data from a first source. The first data is associated with a first source schema and corresponds to instances of types and properties defined in the first source schema.

The method further includes submitting the first data from the first source to a matching model. In response to the submission, results are received from the matching model. The results identify matches between at least a portion of instances of types in the first source schema and instances of types in a second source schema, where the second source schema is either the same as or different from the first source schema. In response to receiving the results, the data in the first source schema is annotated to reflect relationships with corresponding second data in the second source schema.

Example 15 is the method of Example 14, where the annotating includes establishing that an instance of a type in one of the first source schema or the second source schema is derived from an instance of a type in the other source schema.

Example 16 is the method of Example 14 or Example 15, further including training the matching model using data annotated as part of the annotating.

Example 17 is the method of any of Examples 14-16, further including annotating data in the first source schema with an identifier of a version of the matching model used in generating the results.

Example 18 is one or more non-transitory computer-readable storage media that includes computer-executable instructions. When executed by a computing system that includes at least one memory and at least one hardware processor coupled to the memory, the computer-executable instructions cause the computing system to receive first data from a first source. The first data is associated with a first source schema and corresponds to instances of types and properties defined in the first source schema.

The instructions further cause the computing system to submit the first data from the first source to a matching model. In response to the submission, results are received from the matching model. The results identify matches between at least a portion of instances of types in the first source schema and instances of types in a second source schema, where the second source schema is either the same as or different from the first source schema. The instructions further cause the computing system to, in response to receiving the results, annotate the data in the first source schema to reflect relationships with corresponding second data in the second source schema.

Example 19 is the one or more non-transitory computer-readable storage media of Example 18, further including computer-executable instructions that, when executed by the computing system, cause the computing system to train the matching model using data annotated as part of the annotating.

Example 20 is the one or more non-transitory computer-readable storage media of Example 18 or Example 19, further including computer-executable instructions that, when executed by the computing system, cause the computing system to annotate data in the first source schema with an identifier of a version of the matching model used in generating the results.

### EXAMPLE 15

### Computing Systems

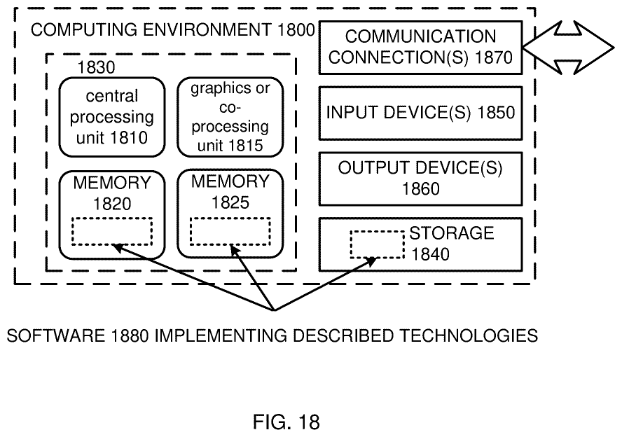

FIG. 18 depicts a generalized example of a suitable computing system 1800 in which the described innovations may be implemented. The computing system 1800 is not intended to suggest any limitation as to scope of use or functionality of the present disclosure, as the innovations may be implemented in diverse general-purpose or special-purpose computing systems.

With reference to FIG. 18, the computing system 1800 includes one or more processing units 1810, 1815 and memory 1820, 1825. In FIG. 18, this basic configuration 1830 is included within a dashed line. The processing units 1810, 1815 execute computer-executable instructions, such as for implementing technologies described in Examples 1-10. A processing unit can be a general-purpose central processing unit (CPU), processor in an application-specific integrated circuit (ASIC), or any other type of processor. In a multi-Rah processing system, multiple processing units execute computer-executable instructions to increase processing power. For example, FIG. 18 shows a central processing unit 1810 as well as a graphics processing unit or co-processing unit 1815. The tangible memory 1820, 1825 may be volatile memory (e.g., registers, cache, RAM), non-volatile memory (e.g., ROM, EEPROM, flash memory, etc.), or some combination of the two, accessible by the processing unit(s) 1810, 1815. The memory 1820, 1825 stores software 1880 implementing one or more innovations described herein, in the form of computer-executable instructions suitable for execution by the processing unit(s) 1810, 1815.

A computing system 1800 may have additional features. For example, the computing system 1800 includes storage 1840, one or more input devices 1850, one or more output devices 1860, and one or more communication connections 1870. An interconnection mechanism (not shown) such as a bus, controller, or network interconnects the components of the computing system 1800. Typically, operating system software (not shown) provides an operating environment for other software executing in the computing system 1800, and coordinates activities of the components of the computing system 1800.

The tangible storage 1840 may be removable or non-removable, and includes magnetic disks, magnetic tapes or cassettes, CD-ROMs, DVDs, or any other medium which can be used to store information in a non-transitory way, and which can be accessed within the computing system 1800. The storage 1840 stores instructions for the software 1880 implementing one or more innovations described herein.

The input device(s) 1850 may be a touch input device such as a keyboard, mouse, pen, or trackball, a voice input device, a scanning device, or another device that provides input to the computing system 1800. The output device(s) 1860 may be a display, printer, speaker, CD-writer, or another device that provides output from the computing system 1800.

The communication connection(s) 1870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 16

### Cloud Computing Environment

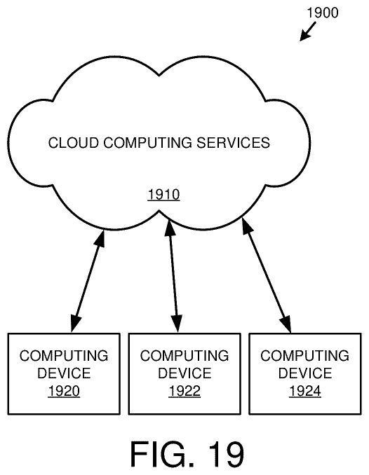

FIG. 19 depicts an example cloud computing environment 1900 in which the described technologies can be implemented. The cloud computing environment 1900 comprises cloud computing services 1910. The cloud computing services 1910 can comprise various types of cloud computing resources, such as computer servers, data storage repositories, networking resources, etc. The cloud computing services 1910 can be centrally located (e.g., provided by a data center of a business or organization) or distributed (e.g., provided by various computing resources located at different locations, such as different data centers and/or located in different cities or countries).

The cloud computing services 1910 are utilized by various types of computing devices (e.g., client computing devices), such as computing devices 1920, 1922, and 1924. For example, the computing devices (e.g., 1920, 1922, and 1924) can be computers (e.g., desktop or laptop computers), mobile devices (e.g., tablet computers or smart phones), or other types of computing devices. For example, the computing devices (e.g., 1920, 1922, and 1924) can utilize the cloud computing services 1910 to perform computing operators (e.g., data processing, data storage, and the like).

### EXAMPLE 17

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 18, computer-readable storage media include memory 1820 and 1825, and storage 1840. The term computer-readable storage media does not include signals and carrier waves. In addition, the term computer-readable storage media does not include communication connections (e.g., 1870).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, C#, Java, Perl, JavaScript, Python, R, Ruby, ABAP, SQL, XCode, GO, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computing system comprising:
at least one hardware processor;
at least one memory coupled to the at least one hardware processor; and
one or more computer-readable storage media comprising computer-executable instructions that, when executed, cause the computing system to perform operations comprising:
receiving first data from a first source, the first data being associated with a first source schema and corresponding to instances of type and properties defined in the first source schema;
submitting the first data from the first source to a matching model;
in response to the submitting, receiving results from the matching model identifying matches between at least a portion of instances of types in the first source schema and instances of types in a second source schema of a second source, wherein the second source schema is either the same as or is different from the first source schema; and
in response to the receiving results, annotating the first data in the first source schema to reflect relationships with corresponding second data in the second source schema;
wherein the annotating further comprises: establishing that a first instance of a first type in the first source schema is derived from a second instance of a second type in the second source schema, or vice versa.

2. The computing system of claim 1, wherein the second source is the first source.

3. The computing system of claim 1, wherein the second source is different from the first source.

4. The computing system of claim 1, wherein the second source schema is different from the first source schema.

5. The computing system of claim 1, wherein the second source schema is the same as the first source schema.

6. (canceled)

7. The computing system of claim 1, wherein the first source schema and the second source schema are implemented as knowledge graphs, and the establishing comprises assigning a predicate to a first relationship between the first instance and the second instance, the predicate indicating that the first relationship is a derivation relationship.

8. The computing system of claim 1, wherein the annotating is performed as part of a process of ingesting the first data from the first source, and the second data comprises data ingested from the second source.

9. The computing system of claim 1, the operations further comprising:
training the matching model using data annotated as part of the annotating.

10. The computing system of claim 9, the operations further comprising:
generating an event indicating that the matching model has received additional training whereby an updated version of the matching model is available.

11. The computing system of claim 10, the operations further comprising:
in response to generating the event, reprocessing previously ingested data using the updated version of the matching model.

12. The computing system of claim 10, the operations further comprising:
generating a new version identifier for the matching model in response to the additional training.

13. The computing system of claim 1, the operations further comprising:
annotating the first data with an identifier of a version of the matching model used in generating the results.

14. A method, implemented in a computing system comprising at least one hardware processor and at least one memory coupled to the at least one hardware processor, the method comprising:
receiving first data from a first source, the first data being associated with a first source schema and corresponding to instances of type and properties defined in the first source schema;
submitting the first data from the first source to a matching model;
in response to the submitting, receiving results from the matching model identifying matches between at least a portion of instances of types in the first source schema and instances of types in a second source schema of a second source, wherein the second source schema is either the same as or is different from the first source schema; and
in response to the receiving results:
annotating the first data in the first source schema to reflect relationships with corresponding second data in the second source schema; and
annotating the first data in the first source schema with an identifier of a version of the matching model used in generating the results.

15. The method of claim 14, wherein the annotating comprises establishing that a first instance of a first type in the first source schema is derived from a second instance of a second type in the second source schema, or vice versa.

16. The method of claim 14, further comprising:
training the matching model using data annotated as part of the annotating.

17. The method of claim 14, further comprising:
annotating data in the first source schema with an identifier of a version of the matching model used in generating the results.

18. One or more non-transitory computer-readable storage media comprising:
first computer-executable instructions that, when executed by a computing system comprising at least one memory and at least one hardware processor coupled to the at least one memory, cause the computing system to receive first data from a first source, the first data being associated with a first source schema and corresponding to instances of type and properties defined in the first source schema;
second computer-executable instructions that, when executed by the computing system, cause the computing system to submit the first data from the first source to a matching model;
third computer-executable instructions that, when executed by the computing system, cause the computing system to, in response to the submitting, receive results from the matching model identifying matches between at least a portion of instances of types in the first source schema and instances of types in a second source schema of a second source, wherein the second source schema is either the same as or is different from the first source schema; and
fourth computer-executable instructions that, when executed by the computing system, cause the computing system to, in response to the receiving results, annotate the first data in the first source schema to reflect relationships with corresponding second data in the second source schema;
wherein the fourth computer-executable instructions, when executed, further cause the computing system to establish that a first instance of a first type in the second source schema is derived from a second instance of a second type in the first source schema, or vice versa.

19. The one or more non-transitory computer-readable storage media of clam 18, further comprising:
fifth computer-executable instructions that, when executed by the computing system, cause the computing system to train the matching model using data annotated as part of the annotating.

20. The one or more non-transitory computer-readable storage media of clam 18, further comprising:
sixth computer-executable instructions that, when executed by the computing system, cause the computing system to annotate the first data in the first source schema with an identifier of a version of the matching model used in generating the results.
